(19) United States
(12) Patent Application Publication
(10) Pub. No.: US 2023/0091509 A1
(43) Pub. Date: Mar. 23, 2023

(54) METHOD FOR DIRECTLY TRANSMITTING ELECTRONIC COIN DATASETS BETWEEN TERMINALS, PAYMENT SYSTEM, PROTECTION SYSTEM AND MONITORING ENTITY

(71) Applicant: GIESECKE+DEVRIENT ADVANCE52 GMBH, München (DE)

(72) Inventors: Tilo FRITZHANNS, Munchen (DE); Florian GAWLAS, Munchen (DE); Maria VELEVA, Munchen (DE)

(21) Appl. No.: 17/802,008

(22) PCT Filed: Feb. 24, 2021
(86) PCT No.: PCT/EP2021/054542

§ 371 Date: Aug. 24, 2022

(30) Foreign Application Priority Data
Feb. 25, 2020 (DE) 10 2020 104 905.6

(51) Int. Cl. G06Q 20/10; G06Q 20/06; G06Q 20/38; G06F 21/64

(52) U.S. Cl. CPC G06Q 20/10; G06Q 20/065; G06Q 20/383; G06F 21/64; G06Q 2220/00

(57) ABSTRACT

The invention relates to a payment system and a method for directly transmitting electronic coin datasets between terminals, wherein a monitoring entity registers anonymous masked electronic coin datasets. The method has the following steps in a first terminal; receiving an electronic coin dataset, said at least one electronic coin dataset having a monetary value and a concealment value; masking a modified electronic coin dataset or the received electronic coin dataset by applying a one-way function to the electronic coin dataset in order to obtain a masked electronic coin dataset; linking the masked electronic coin dataset to a pseudonym in order to obtain a pseudonymized masked electronic coin dataset, and transmitting the pseudonymized masked electronic coin dataset to the monitoring entity.

### TECHNICAL FIELD OF THE INVENTION

The invention relates to a method for directly transmitting electronic coin datasets between terminals. The invention further relates to a payment system for exchanging monetary values. The invention further relates to a monitoring entity.

### TECHNICAL BACKGROUND OF THE INVENTION

Security of payment transactions and associated payment transaction data means protecting the confidentiality of the exchanged data, as well as protecting the integrity of the exchanged data; as well as protecting the availability of the exchanged data.

Traditional blockchain-based payment transactions, such as Bitcoin, present a high level of integrity protection. When electronic coin datasets, also called “coins”, change the owner in a blockchain technology, a lot of information is made public. Thus, such payment transactions and in particular the exchanged data are not completely confidential. In addition, the payment transactions are very computationally intensive and therefore energy-intensive.

Therefore, traditionally, instead of the confidential data, only the hash values of the confidential data are stored in a blockchain ledger. The corresponding plaintext data must then be managed outside the blockchain. So far, such concepts are not applicable for electronic coin datasets because they do not have basic surveillance functions, in particular (1) methods for detection of multiple spending, also called double spending, and (2) the detection of uncovered payments. In case (1), someone tries to spend the same coin dataset multiple times and in the second case someone tries to spend a coin dataset although he has no credit (anymore).

From DE 10 2009 038 645 A1 and DE 10 2009 034436 A1, systems are known for transmitting monetary values in the form of electronic datasets, in which payment with duplicates of the dataset is prevented and a high degree of manipulation security is provided, wherein in this case complex structures and elaborate encryption and signing processes are required for the exchange. These have proven to be of little practical use.

In WO 2016/200885 A1, a method for encrypting a value transacted in a blockchain ledger is described wherein the verifiability of the transaction is maintained. In this process, an concealment value is added to an input value. An output value is then generated and encrypted. Both the input value and the output value are within a range of values, wherein a sum of any two values within the range does not exceed a threshold value. The sum of the encrypted input value and the encrypted output value can be equal to zero. Range checks, called range proofs, are associated with each of the input values and the output value. These range checks prove that the input value and the output value fall within the range of values. Each public key can be signed with a ring signature which is based on a public key of a recipient in the transaction. In this method, a blockchain technology is required to be invoked upon receipt of a coin dataset to validate the coin dataset.

It is the object of the present invention to provide a method and a system in which a payment transaction is secure yet simple. In particular, a direct payment between devices, such as tokens, smartphones, but also machines, such as cash terminals or vending machines, is to be created, which is initially anonymous. It should be possible for the user to combine and/or divide multiple coin datasets as desired in order to enable flexible exchange. The exchanged coin datasets should on the one hand be confidential towards other system participants, but on the other hand allow each system participant to perform basic monitoring checks, in particular the detection of multiple spending attempts and the detection of attempts to pay with non-existent monetary values. In the future, it should be possible to dispense with cash (banknotes and analogue coins) altogether, or at least with analogue coins.

The transmitting of coin datasets is anonymous as long as the anonymity is not explicitly removed by additional measures. It could be a requirement to remove anonymity in dependence of a value for monetary values. In other words, a typical requirement in the payment system could be to send monetary values anonymously below a certain threshold. If this threshold is exceeded, the transmission would be de-anonymized in the system.

Since a payment transaction (transmission of coin datasets) of a large monetary value could also be split into multiple payment transactions of smaller monetary values, each of which could be below the threshold, the threshold should be terminal-specific and time period-dependent. Moreover, due to the non-transparent multiple (direct) transmission of a coin dataset between a plurality of different terminals, this requirement for de-anonymization, also called re-identification, is not directed to individual transmissions (transactions) between two terminals, but generally relates to the sum of all transactions within a certain time unit (duration) that are received and/or sent by a terminal. A mechanism is therefore needed to determine the sum of all monetary values sent or received by a terminal within a given time unit. In other words, a method is needed that enables the removal of anonymity from a sending terminal when exceeding a threshold value per time unit.

### SUMMARY OF THE INVENTION

The objects posed are solved with the features of the independent patent claims. Further advantageous embodiments are described in the dependent patent claims.

The object is solved in particular by a method for directly transmitting electronic coin datasets between terminals, wherein a monitoring entity registers anonymous masked electronic coin datasets, comprising the following steps in a first terminal; receiving an electronic coin dataset, the at least one electronic coin dataset having a monetary value and a concealment value; masking a modified electronic coin dataset or the received electronic coin dataset by applying a one-way function, which is for example homomorphic, to the electronic coin dataset, preferably to its concealment value, in order to obtain a masked electronic coin dataset; linking the masked electronic coin dataset to a pseudonym in order to obtain a pseudonymized masked electronic coin dataset; and sending the pseudonymized masked electronic coin dataset to the monitoring entity.

The steps described herein need not be performed in the order described. However, the order described herein is a preferred embodiment. In particular, the linking step may be interchanged with the masking step.

An electronic coin dataset is in particular an electronic dataset that represents a monetary value and is also colloquially referred to as a “digital coin” or “electronic coin”. This monetary value exchanges from one terminal to another during the method. In the following, a monetary value is understood as a digital value that can be credited e.g. to an account of a financial institution or can be exchanged for another means of payment. An electronic coin dataset thus represents cash in electronic form.

The terminal may have a plurality of electronic coin datasets, for example, the plurality of coin datasets may be stored in a data memory of the terminal. The data memory then represents, for example, an electronic wallet. The data memory may, for example, be internal, external or virtual. In one embodiment, upon receipt of an electronic dataset, a “connecting” may take place automatically, so that preferably only one (or a certain number of) electronic dataset(s) is/are in the terminal.

For example, the terminal may be a passive device such as e.g. a token, a mobile terminal such as e.g. a smartphone, a tablet computer, a computer, a server or a machine.

An electronic coin dataset for transmitting monetary values differs substantially from an electronic dataset for data exchange or data transfer, since, for example, a classical data transaction takes place on the basis of a question-answer principle or on an intercommunication between the data transfer partners. An electronic coin dataset, on the other hand, only exists once, is unique and stands in the context of a security concept, which can comprise masking, signatures or encryption, for example. In principle, an electronic coin dataset comprises all the data required by a receiving entity for verification, authentication and forwarding to other entities. Intercommunication between the terminals during the exchange is therefore in principle not necessary for this type of dataset.

According to the invention, an electronic coin dataset used for transmitting between two terminals has a monetary value, i.e. a datum representing a monetary value of the electronic coin dataset, and a concealment value, for example a random number. In addition, the electronic coin dataset may have further metadata, such as what currency the monetary value represents. An electronic coin dataset is uniquely represented by these at least two data (monetary value and concealment value). Anyone who has access to these two data of a valid coin dataset can use this electronic coin dataset for payment. Knowing these two values (monetary value and concealment value) is therefore equivalent to possession of the digital money. This electronic coin dataset is transmitted directly between two terminals. In one embodiment of the invention, an electronic coin dataset consists of these two data, thus only the transmission of the monetary value and of the concealment value is necessary for exchange of digital money.

A corresponding masked electronic coin dataset is associated with each electronic coin dataset. Knowledge of a masked electronic coin dataset does not authorize the issuance of the digital money represented by the electronic coin dataset. This represents a key difference between masked electronic coin datasets and the (non-masked) electronic coin datasets and is the essence of the invention present herein. A masked electronic coin dataset is unique and can also be uniquely associated with an electronic coin dataset, so there is a 1-to-1 relationship between a masked electronic coin dataset and a (non-masked) electronic coin dataset. The masking of the electronic coin dataset is preferably performed by a computing unit of the terminal within the terminal. The terminal has at least one electronic coin dataset. Alternatively, masking may be performed by a computing unit of the terminal receiving the electronic coin dataset.

This masked electronic coin dataset is obtained by applying a one-way function, for example a homomorphic one-way function, for example a cryptographic function. This function is a one-way function, thus a mathematical function that is “easy” to calculate in terms of complexity theory, but “difficult” to practically impossible to reverse. In this context, one-way function also refers to a function for which no inversion is known that can be practically executed in a reasonable amount of time and with a reasonable amount of effort. Thus, the calculation of a masked electronic coin dataset from an electronic coin dataset is comparable to or corresponds to the generation of a public key in an encryption method via a residue class group. Preferably, a one-way function is used that operates on a group in which the discrete logarithm problem is difficult to solve, such as e.g. a cryptographic method analogous to an elliptic curve encryption, or ECC, from a private key of a corresponding cryptographic method. The reverse function, thus the generation of an electronic coin dataset from a masked electronic coin dataset (or the part of the electronic coin dataset), is thereby —equivalent to the generation of the private key from a public key in an encryption method over a residue class group—very time-consuming. Whenever sums and differences or other mathematical operations are mentioned in the present document, the respective operations on the corresponding mathematical group are to be understood in the mathematical sense, for example the group of points on an elliptical curve.

In one embodiment, the one-way function is homomorphic, thus a cryptographic method which has homomorphism properties. As such, mathematical operations can be performed on the masked electronic coin dataset that can also be performed in parallel on the (non-masked) electronic coin dataset and thus be traced. Using the homomorphic one-way function, calculations with masked electronic coin datasets can be traced in the monitoring entity without the corresponding (non-masked) electronic coin datasets being known there. Therefore, certain calculations with electronic coin datasets, for example for processing the (non-masked) electronic coin dataset (for example splitting or connecting), can also be verified in parallel with the corresponding masked electronic coin datasets, for example for validation checks or for monitoring the legitimacy of the respective electronic coin dataset. The homomorphism properties apply at least to addition and subtraction operations so that a splitting or combining (=connecting) of electronic coin datasets can also be recorded in the monitoring entity by means of the corresponding masked electronic coin datasets and can be traced by requesting terminals and/or by the monitoring entity without gaining knowledge about the monetary value and the performing terminal.

The homomorphism property thus allows a record of valid and invalid electronic coin datasets to be maintained on the basis of their masked electronic coin datasets in a monitoring entity without knowledge of the electronic coin datasets, even if these electronic coin datasets are being processed (split, connected, switched). This ensures that no additional monetary value has been created or that an identity of the terminal is recorded in the monitoring entity. Masking allows a high level of security without giving any insight into the monetary value or the terminal. This results in a two-layer payment system. On the one hand, there is the processing layer in which masked electronic datasets are checked and on the other hand, there is the direct transaction layer in which at least two terminals transmit electronic coin datasets.

In a further embodiment, the one-way function is a cryptographic encryption function.

Applying the one-way function to the electronic coin dataset also comprises applying the one-way function to a part of the electronic coin dataset, in particular to the concealment value, in one embodiment only to the concealment value.

When transmitting an electronic coin dataset from the first terminal to the second terminal, two terminals have knowledge of the electronic coin dataset. In order to prevent the transmitting first terminal from also using the electronic coin dataset for payment at another (third) terminal (so-called double spending), a switch of the transmitted electronic coin dataset from the first terminal to the second terminal is preferably carried out. The switch can preferably take place automatically upon receipt of an electronic coin dataset in the second terminal. In addition, it may also occur on request, for example a command from the first and/or second terminal. In addition, it may also occur on request, for example a command from the first and/or second terminal. Additionally, an electronic coin dataset can also be divided into at least two coin subdatasets (“split”). In addition, two electronic coin datasets can be connected to form one coin dataset (“merge”).

Switching, splitting and connecting are different modifications to an electronic coin dataset. These modifications require the masked coin dataset to be registered in a monitoring entity. This registration in the course of the modifications causes the electronic coin dataset sent by the first terminal to become invalid and to be recognized as correspondingly invalid in a second spending attempt by the first terminal. The coin dataset to be registered by the second terminal becomes valid by being registered in the monitoring entity. The particular performance of the individual modifications will be explained later.

Switching also occurs when an electronic coin dataset has been modified, for example split or connected to other electronic coin datasets, in particular to be able to suitably settle a monetary value to be paid. In this context, a digital payment system should be able to pay any monetary value under any circumstances.

Also to enable the required mechanism for de-anonymization, a linking step is performed before masking in order to link a pseudonym of the terminal to the electronic coin dataset. The pseudonym is preferably terminal-specific. A pseudonym is any type of concealed identity that allows direct inference to the terminal and the transactions performed with it not in mere knowledge of the coin dataset.

The terminal must perform a modification (splitting, switching, connecting) for each coin dataset received in order to link the pseudonym to the coin dataset. The registration in the monitoring entity associated with each modification (for validating the modification) is sufficient to be able to uniquely associate all coin dataset transactions performed with the terminal to that terminal based on the linked pseudonym. Knowing that the pseudonym and the terminal belong together, the monitoring entity can identify the transactions arriving at the terminal.

Thus, modifications of the coin dataset are linked to a pseudonym stored on the terminal. This pseudonym can be either permanent or valid only for a specific time period.

The difference between an anonymous masked coin dataset and a pseudonymized masked coin dataset is thus the identifiability of the terminal by the monitoring entity when it uses the pseudonym. An anonymous masked coin dataset does not comprise any information about its origin, so it cannot be associated with a terminal. In contrast, a pseudonymized masked coin dataset has a linking to a pseudonym of the terminal so that the terminal that sent the pseudonymized masked coin dataset to the monitoring entity can be identified by the linked pseudonym.

The mechanism described is sufficient in order to determine whether the sum of the monetary values of all transactions of a terminal are below a threshold value, preferably within a certain time unit. If it is detected that the threshold is exceeded by a desired modification, the monitoring entity could promptly prevent such a modification by refusing to register the corresponding coin dataset. Alternatively or additionally, the terminal could be informed that the modification (and thus the transaction) would only be carried out if the terminal de-anonymizes itself, thus for example discloses personal access data, before the modification is registered and the coin dataset is set to valid, thereby accepting the transaction.

In a preferred embodiment, by sending the pseudonymized masked electronic coin dataset instead of an anonymous masked electronic coin dataset, the number of range confirmations or range proofs that the monitoring entity requests from the first terminal is reduced.

The monitoring entity and/or the first terminal may process the masked electronic coin dataset in an anonymous or in a pseudonymous mode. In an anonymous mode, the monitoring entity requests necessary and further (to be caught-up) range proofs or range confirmations. In pseudonymous mode, the monitoring entity does not request at least one of the further range proofs or range confirmations, but checks for the pseudonym whether a (catch-up) criterion is met. A coin dataset can already be treated as valid if the necessary checks have been made. Only when the (catch-up) criterion is fulfilled are range proofs or a sum range proof (or confirmation) requested by the terminal. As (catch-up) criteria, for example, a time period or a number of masked coin datasets can be used for the pseudonym.

In a preferred embodiment, the first terminal receives a request for a sum range confirmation or a sum range proof from the monitoring entity and sends the requested sum range confirmation or sum range proof to the monitoring entity.

In an alternative embodiment, the first terminal creates an unsolicited sum range confirmation or an unsolicited sum range proof and sends the unsolicited sum range confirmation or the requested sum range proof to the monitoring entity.

A sum range confirmation or sum range proof here is an indication by the terminal of a sum of monetary values of a multiplicity of coin datasets, preferably coin datasets transmitted directly between terminals. This sum indication is compared with a range indication in the monitoring entity. If the range indication is exceeded, the coin datasets are de-anonymized in order to be able to secure or surveil the transmission of large monetary values.

Preferably, the first terminal forms a sum of monetary values of multiple electronic coin datasets confirmed with the sum range confirmation that the formed sum is in a range. The sum range confirmation is understood in the monitoring entity as an indication of the terminal and the terminal is classified trustworthy.

In an alternative embodiment, the first terminal creates a sum range proof for multiple electronic coin datasets which can be checked by the monitoring entity. The sum range is thus then checked by the monitoring entity and confirmation is made there that the sum is (or is not) in the range.

In a preferred embodiment, the multiple electronic coin datasets comprise only selected electronic coin datasets. Thus, the sum range confirmation or the sum range proof is not performed for all coin datasets of the terminal, but only for a targeted selection. In one embodiment, the selection relates to only electronic coin datasets of sent pseudonymized masked electronic coin datasets. In an alternative embodiment, only electronic coin datasets from sent anonymous masked electronic coin datasets or sent pseudonymized masked electronic coin datasets are affected. In an alternative embodiment, only electronic coin datasets from sent anonymous masked electronic coin datasets, sent pseudonymized masked electronic coin datasets and/or masked electronic coin datasets not sent to the monitoring entity are affected.

In a preferred embodiment, the multiple electronic coin datasets are selected according to a preselected time period as a selection criterion. The time period selected may be a day, a week, or a much lesser time period. In an alternative or additional embodiment, a list in the first terminal or the monitoring entity is to be used as the selecting criterion on the basis of which list the coin datasets are selected.

In a preferred embodiment, the monitoring entity requests range confirmations or range proofs from terminals as part of a sum check. Preferably, the monitoring entity applies a first sum check mode for anonymous masked electronic coin datasets. Preferably, the monitoring entity applies a second sum check mode for pseudonymized masked electronic coin datasets.

In a preferred embodiment, the monitoring entity checks a range proof for each modified coin dataset received.

In a preferred embodiment, the monitoring entity regularly or quasi-randomly requests range confirmations or range proofs from terminals. This is done, for example, in the first sum check mode.

In an alternative or additional embodiment, the monitoring entity requests a range confirmation or range proof from the terminal only after a number of coin datasets are received for a pseudonym. This is done, for example, in the second sum check mode. This number is preferably dependent on the terminal type and/or coin value range. Thus, the range proofs or range confirmations can be flexibly adapted to a specific user situation and thus increase the security of the payment system.

Furthermore, the method comprises the following steps: Masking the transmitted electronic coin dataset by applying the, for example homomorphic, one-way function to the transmitted electronic coin dataset in order to obtain a masked electronic coin dataset; linking the masked transmitted electronic coin dataset in the second terminal to a pseudonym of the second terminal in the second terminal in order to obtain a pseudonymized masked transmitted electronic coin dataset; and sending the pseudonymized masked transmitted electronic coin dataset to the monitoring entity in order to check the validity of the transmitted electronic coin dataset by the monitoring entity.

The monitoring entity can thus identify the outgoing transactions at the terminal also when it knows that the pseudonym and the terminal belong together.

The steps described here do not have to be performed in the order described. However, the order described here is a preferred embodiment.

In particular, the order of the linking step and the masking step can be interchanged.

In principle, identifying the outgoing transactions or the incoming transactions is sufficient so that in one embodiment masking the electronic coin dataset and linking the masked electronic coin dataset in the second terminal with a pseudonym of the second terminal in the second terminal and sending the pseudonymized masked electronic coin dataset to the monitoring entity is not performed.

The linking step is preferably performed by signing the respective masked electronic coin dataset in the second terminal with a private signature key of the second terminal in order to obtain a signed masked electronic coin dataset as a pseudonymized masked electronic coin dataset or as a pseudonymized masked transmitted electronic coin dataset.

The signing is done with a private signature key of the terminal. This signature key is preferably terminal-specific, i.e. knowing the verification key, it can be traced who last modified (switched, split, connected) the coin dataset. The signed masked coin dataset is registered in the monitoring entity.

In order to generate a signature, an asymmetric cryptosystem is thus preferred in which the terminal calculates a value for a dataset using a secret signature key, referred to here as a private signature key or “private key”. This value enables anyone to check the authorship and integrity of the dataset using a public verification key, the “public key”.

Preferably, with the step of registering, a check of the signature will take place in the monitoring entity, the monitoring entity having the public verification key of the signature for this purpose. The signature can now be checked by the monitoring entity by knowing a public verification key of the signature there.

The public verification key for checking the signature is preferably only known to the monitoring entity whereby the method remains anonymous for the participants (terminals) among each other.

Preferably, the monitoring entity registers any modification, thus switching, splitting and/or connecting together with the signature of the second terminal. This way, monitoring and determining the sum of monetary values for all transactions of a terminal may be performed by the monitoring entity.

Preferably, the signature is valid within a certain time unit, wherein the certain time unit is preferably a day. Thus, the transaction volume (=sum of monetary values for transactions) per terminal can be checked for this specific time unit.

Each terminal therefore has an asymmetric key pair in order to sign each modification with the private signature key. The public key is known to the monitoring entity. Thus, the monitoring entity can link each transaction to a terminal as the sender or recipient of the coin dataset.

The mechanism described is sufficient to detect (measure) whether the sum of all monetary values per terminal (=transactions) is within a threshold value per time unit, for example a daily threshold value.

Splitting and subsequent registration has the advantage that an owner of the at least one electronic coin dataset is not forced to always transmit the entire monetary value at once, but to now form and transmit corresponding monetary subvalues. The monetary value can be split asymmetrically without any restrictions as long as all electronic coin data subsets have a positive monetary value that is smaller than the monetary value of the electronic coin dataset from which it is split and the sum of the electronic coin subdatasets is equal to the electronic coin subdataset to be split. Alternatively or additionally, fixed denominations can be used. The splitting into subvalues is arbitrary as long as all subvalues are of the same size.

The method preferably has the further following steps: Switching the transmitted electronic coin dataset; and/or connecting the transmitted electronic coin dataset with a second electronic coin dataset to form a further electronic coin dataset, namely connected electronic coin dataset.

Upon switching, the electronic coin subdataset received from the first terminal results in a new electronic coin dataset, preferably with the same monetary value, called the electronic coin dataset to be switched. The new electronic coin dataset is generated by the second terminal, preferably by using the monetary value of the received electronic coin dataset as the monetary value of the electronic coin dataset to be switched. In doing so, a new concealment value, for example a random number, is generated. The new concealment value is added to the concealment value of the received electronic coin dataset, for example, so that the sum of both concealment values (new and received) serves as the concealment value of the electronic coin dataset to be switched. After switching, the received electronic coin subdataset and the electronic coin subdataset to be switched are preferably masked in the terminal by applying, for example, the homomorphic one-way function to the received electronic coin subdataset and the electronic coin subdataset to be switched, respectively, in order to obtain a masked received electronic coin subdataset and a masked electronic coin subdataset to be switched, respectively.

The switching is thus secured by adding a new concealment value to the concealment value of the received electronic coin dataset, thereby obtaining an concealment value known only to the second terminal. Newly created concealment values must have a high entropy as they are used as a blinding factor for the corresponding masked electronic subdatasets. Preferably, a random number generator on the terminal is used for this purpose. This safeguarding can be tracked in the monitoring entity.

Preferably, as part of the switching, additional information needed to register the switching of the masked electronic coin dataset in the remote monitoring entity is calculated in the terminal. Preferably, the additional information includes a range proof of the masked electronic coin dataset to be switched and a range proof of the masked received electronic coin dataset. The range proof is a proof that the monetary value of the electronic coin dataset is non-negative, the electronic coin dataset is validly created and/or the monetary value and the concealment value of the electronic coin dataset are known to the creator of the range proof. In particular, the range proof is used to provide this (these) verification(s) without revealing the monetary value and/or the concealment value of the masked electronic coin dataset. These range proofs are also called “zero-knowledge range proofs”. Preferably, ring signatures are used as range proofs. Subsequently, a registration of the switching of the masked electronic coin dataset is performed in the remote monitoring entity.

Preferably, the registering step is performed when the second terminal is connected to the monitoring entity. While the electronic coin datasets are used for direct payment between two terminals, the masked coin datasets are registered with the pseudonym in the monitoring entity.

In a further preferred embodiment of the method, a further electronic coin dataset (connected electronic coin dataset) is determined from a first and a second electronic coin subdataset for connecting of electronic coin subdatasets. Thereby, the concealment value for the electronic coin dataset to be connected is calculated by forming the sum of the respective concealment values of the first and the second electronic coin dataset. Further, the monetary value for the connected electronic coin dataset is preferably calculated by taking the sum of the respective monetary values of the first and second electronic coin datasets.

After connecting, the first electronic coin subdataset, the second electronic coin subdataset, and the electronic coin dataset to be connected are stored in the (first and/or second) terminal by applying, for example, the homomorphic one-way function to each of the first electronic coin subdataset, the second electronic coin subdataset, and the electronic coin dataset to be connected, respectively, in order to obtain a masked first electronic coin subdataset, a masked second electronic coin subdataset, and a masked electronic coin dataset to be connected, respectively. Further, additional information required for registering the connection of the masked electronic coin datasets in the remote monitoring entity is calculated in the terminal. Preferably, the additional information includes a range proof on the masked first electronic coin subdataset and a range proof on the masked second electronic coin subdataset. The range proof is a proof that the monetary value of the electronic coin dataset is non-negative, the electronic coin dataset is validly created and/or the monetary value and the concealment value of the electronic coin dataset are known to the creator of the range proof. In particular, the range proof is used to provide this (these) proof(s) without revealing the monetary value and/or the concealment value of the masked electronic coin dataset. These range proofs are also called “zero-knowledge range proofs”. Preferably, ring signatures are used as range proofs. This is followed by registering the connection of the two masked electronic coin records in the remote monitoring entity.

By using the pseudonyms per terminal, the monitoring entity can now preferably request a range from each terminal, not only to prove that for a single transaction the monetary value is between a valid minimum and maximum value, but it is now also possible that a sum of all transactions, for example within a time unit, is within a predefined limit value, preferably for that time unit.

With the step of connecting, two electronic coin datasets or two electronic coin subdatasets can be combined. In this process, the monetary values as well as the concealment values are added. Thus, as with splitting, a validity of the two original coin datasets can be performed upon connecting.

In a preferred embodiment, the registering step comprises receiving the masked coin dataset to be switched in the monitoring entity, checking the masked coin dataset to be switched for validity; and registering the masked coin dataset to be switched in the monitoring entity if the checking step is successful, whereby the coin dataset to be switched is deemed to be checked.

According to the invention, there is also provided a terminal configured for directly transmitting electronic coin datasets between terminals having a computing unit configured for carrying out the steps of the method of the kind described above.

According to the invention, there is also provided a monitoring entity configured for directly transmitting electronic coin datasets between terminals having a computing unit configured for carrying out the method of the kind described above.

According to the invention, there is also provided a two-layer payment system of a direct payment transaction layer, for the direct exchange of (non-masked) electronic coin datasets, and a monitoring layer, which may also be referred to as an “concealed electronic dataset ledger”, and in which the method described above may be carried out. The payment system serves for exchanging monetary values. In the monitoring entity, the monitoring layer, no payment transactions are recorded, but exclusively masked electronic coin datasets, their pseudonyms and their modifications for the purpose of verifying the validity of (non-masked) electronic coin datasets. This ensures the anonymity of the participants in the payment system. The monitoring entity provides information about valid and invalid electronic coin datasets, for example to avoid multiple issuance of the same electronic coin dataset or to verify the authenticity of the electronic coin dataset as validly issued electronic money or to detect the sum of monetary values per terminal in order to compare this sum with a limit value and to prevent or allow modification accordingly.

The terminal may in the present case have a security element in which the electronic coin datasets are securely stored. A security element is preferably a special computer program product, in particular in the form of a secure runtime environment within an operating system of a terminal, Trusted Execution Environments, TEE, stored on a data storage device, for example, of a mobile terminal, a machine, preferably an automatic teller machine. Alternatively, the security element is configured, for example, as special hardware, in particular in the form of a secure hardware platform module, Trusted Platform Module, TPM, or as an embedded security module, eUICC, eSIM. The security element provides a trusted environment.

The communication between two terminals can be wireless or wired, or e.g. also by optical means, preferably via QR code or barcode, and can be configured as a secure channel. The optical path can comprise, for example, the steps of generating an optical code, in particular a 2D code, preferably a QR code, and reading the optical code. Thus, the exchange of the electronic coin dataset is secured, for example, by cryptographic keys, such as a session key negotiated for an electronic coin dataset exchange or a symmetric or asymmetric key pair.

By communicating between terminals, for example via their security elements, the exchanged electronic coin datasets are protected against theft or manipulation. The level of security elements thus complements the security of established blockchain technology.

In a preferred embodiment, the coin datasets are transmitted as APDU commands. For this purpose, the coin dataset is preferably stored in an (embedded) UICC as a security element and is managed there. An APDU is a combined command/data block of a connection protocol between the UICC and a device. The structure of the APDU is defined by the ISO-7816-4 standard. APDUs represent an information element of the application layer (layer 7 of the OSI layer model).

Furthermore, it is advantageous that the electronic coin datasets can be transmitted in any format. This implies that they can be communicated, thus transmitted, on any channels. They do not have to be stored in a fixed format or in a specific program.

A terminal is in particular considered to be a mobile telecommunication terminal, for example a smartphone. Alternatively or additionally, the terminal may also be a device, such as a wearable, smart card, machine, tool, vending machine or even container or vehicle. A terminal according to the invention is thus either stationary or mobile. The terminal is preferably configured to use the Internet and/or other public or private networks. For this purpose, the terminal uses a suitable connection technology, for example Bluetooth, Lora, NFC and/or WiFi, and has at least one corresponding interface. The terminal can also be configured to be connected to the internet and/or other networks by access to a mobile network.

In one embodiment, in the method described, it can be provided that the first and/or second terminal processes the received electronic coin datasets according to their monetary value if multiple electronic coin datasets are present or have been received. Thus, it can be provided that electronic coin datasets with a higher monetary value are processed before electronic coin datasets with a lower monetary value. In one embodiment, the first and/or second terminals may be configured, after receiving an electronic coin dataset, to connect it in dependence on attached information, such as a currency or denomination, with an electronic coin dataset already present in the second terminal, and to perform a connecting step accordingly. Furthermore, the second terminal may also be configured to automatically perform a switching after receiving the electronic coin dataset from the first terminal.

In one embodiment, further information, in particular metadata, is transmitted from the first terminal to the second terminal during the transmission, for example a currency. In one embodiment, this information may be comprised by the electronic coin dataset.

In a preferred embodiment, the monitoring entity is a remote entity. This provides, for example, for the establishment of a communication connection to the monitoring entity in order to register the electronic coin dataset. This communication connection does not necessarily have to be present during the payment process. Instead, the sending (first) terminal can also delegate the splitting and/or connecting and/or switching to the receiving (second) terminal.

The monitoring entity is designed as a higher-level entity. Accordingly, the monitoring entity is not necessarily arranged in the level or layer of the terminals (direct transaction layer). Preferably, the monitoring entity is provided for the administration and verification of masked electronic coin datasets and is arranged in an issuer layer, in which an issuer entity is also arranged, and/or in a monitoring layer.

It is conceivable that the monitoring entity additionally manages and checks transactions between terminals.

The monitoring entity is preferably a decentrally controlled database, known as Distributed Ledger Technology, DLT, in which the masked electronic coin datasets are registered with corresponding processing of the masked electronic coin dataset. In a preferred embodiment, a validity status of the (masked) electronic coin dataset can be derived therefrom. Preferably, the validity of the (masked) electronic coin dataset is noted in and by the monitoring entity. The registration of the processing or processing steps may also concern the registration of check results and intermediate check results concerning the validity of an electronic coin dataset. If a processing is final, this is displayed, for example, by corresponding markings or a derived overall marking. Final processing then determines whether an electronic coin dataset is valid or invalid. In this way, exceeding a transaction volume can result in a modification being declared invalid.

This database is further preferably a non-public database, but can also be implemented as a public database. This database makes it possible in a simple manner to check coin datasets with regard to their validity and to prevent “double spending”, thus multiple spending, without the payment transaction itself being registered or logged. DLT describes a technique for networked computers to agree on the order of certain transactions and that these transactions update data. It corresponds to a decentralized management system or decentrally maintained database.

In a further embodiment, the database may also be designed as a public database.

Alternatively, the monitoring entity is a centrally maintained database, for example in the form of a publicly accessible data storage or as a hybrid of a centralized and decentralized database.

Preferably, the at least one initial electronic coin dataset is exclusively created by the issuer entity, whereby preferably the split electronic coin datasets, in particular electronic coin subdatasets, can also be generated by a terminal. Preferably, creating and selecting a monetary value also includes selecting a high entropy concealment value. The issuer entity is a computing system, which is preferably remote from the first and/or second terminal. After creating the new electronic coin dataset, the new electronic coin dataset is masked in the issuer entity by applying the, for example homomorphic, one-way function to the new electronic coin dataset in order to accordingly obtain a masked new electronic coin dataset. Further, additional information needed to register the creating of the masked new electronic coin dataset in the remote monitoring entity is calculated in the issuer entity. Preferably, this further information is proof that the (masked) new electronic coin dataset originates from the issuer entity, for example by signing the masked new electronic coin dataset. In one embodiment, the issuer may sign a masked electronic coin dataset with its signature when creating the electronic coin dataset. The signature of the issuer entity is stored in the monitoring entity for this purpose. The signature of the issuer entity is different from the generated signature of the first terminal.

Preferably, the issuer entity can deactivate an electronic coin dataset in its possession (thus of which it knows the monetary value and the concealment value) by masking the masked electronic coin dataset to be deactivated with, for example, the homomorphic one-way function and preparing a deactivate command for the monitoring entity. Part of the deactivate command is preferably, besides the masked electronic coin dataset to be deactivated, also the proof that the deactivate step was initiated by the issuer entity, for example in the form of the signed masked electronic coin dataset to be deactivated. As additional information, range checks for the masked electronic coin dataset to be deactivated could be comprised in the deactivate command. The deactivation of the masked electronic coin dataset is subsequently registered in the remote monitoring entity. The deactivate step is triggered by the deactivate command.

The create and deactivate steps are preferably performed in secure locations, in particular not in the terminals. In a preferred embodiment, the steps of creating and deactivating are only performed or initiated by the issuer entity. Preferably, these steps take place in a secure location, for example in a hardware and software architecture designed to method sensitive data material in insecure networks. Deactivating the corresponding masked electronic coin dataset causes the corresponding masked electronic coin dataset to no longer be available for further processing, in particular transactions, as it has been marked as invalid in and by the monitoring entity. However, in one embodiment, it may be provided that the deactivated masked electronic coin dataset remains in archival form at the issuer entity. The fact that the deactivated masked electronic coin dataset is no longer valid may be indicated, for example, by means of a flag or other coding, or the deactivated masked electronic coin dataset may be destroyed and/or deleted. Of course, the deactivated masked electronic coin dataset can also be physically removed from the terminal.

The method according to the invention enables various processing operations (modifications) to be performed on the electronic coin datasets and the corresponding masked electronic coin datasets. Each of the processing operations (in particular creating, deactivating, splitting, connecting and switching) is in this case registered in the monitoring entity and appended to the list of previous processing operations for the respective masked electronic coin dataset in an unchangeable form. The registration is independent of the payment process between the terminals in terms of both time and location (spatially). The processing operations “create” and “deactivate”, which concern the existence of the monetary value itself, thus mean the creation and destruction up to the extinction of money, require an additional authorization, for example in the form of a signature, by the issuer entity in order to be registered (thus logged) in the monitoring entity. The remaining processing operations (split, connect, switch), of which splitting and connecting can also be delegated by a terminal to a further terminal, do not require authorization by the issuer entity or by the command initiator (=payer, e.g. the first terminal).

Processing in the direct transaction layer relates only to the possession situation and/or association of the coin datasets to terminals of the respective electronic coin datasets. A registration of the respective processing in the monitoring entity is realized, for example, by corresponding list entries in a database, which comprises a number of markings to be performed by the monitoring entity. A possible structure for a list entry comprises, for example, column(s) for a predecessor coin dataset, column(s) for a successor coin dataset, a signature column for the issuer entity, a signature column for the sending and/or receiving terminal, a signature column for coin distribution processes and at least one marking column. A change in the status of the marking requires the approval of the monitoring entity and must then be stored unchangeably. A change is final if and only if the required markings have been validated by the monitoring entity, i.e. changed from “0” status to “1” status after the corresponding check, for example. If a check fails or takes too long, it is changed from “-” status to “0” status instead, for example. Further status values are conceivable and/or the status values mentioned here are interchangeable. Preferably, the validity of the respective (masked) electronic coin datasets is summarized from the status values of the markings, each in a column for each masked electronic coin dataset involved in the registering processing.

In a further embodiment, at least two, preferably three, or even all of the aforementioned markings may also be replaced by a single marking that is set when all checks have been successfully completed. Furthermore, the two columns each for predecessor datasets and successor datasets can be combined into one column each, in which all coin datasets are listed in combination. This would make it possible to manage more than two electronic coin datasets per field entry and thus, for example, to split them into more than two coin datasets.

The checks by the monitoring entity in order to check whether a processing is final are already described above and are in particular:
are the masked electronic coin datasets of the predecessor column(s) valid?
does monitoring result in the correct check value?
are the range proofs for the masked electronic coin datasets successful?
is the signature of the masked coin electronic dataset a valid signature of the issuer entity?
does the sending/receiving terminal (pseudonym) exceed a limit value for a maximum permissible monetary value, in particular per time unit?

Preferably, it also holds that a masked electronic coin dataset is invalid if one of the following checks applies, thus if:
(1) the masked electronic coin dataset is not registered in the monitoring entity;
(2) the last processing of the masked electronic coin dataset indicates that there are predecessor coin datasets for it, but this last processing is not final; or
(3) the last processing of the masked electronic coin dataset indicates that there are successor coin datasets for it and this last processing is final;
(4) the masked electronic coin dataset is not the successor to a valid masked electronic dataset unless it is signed by the issuer entity;
(5) the monetary value of the masked electronic coin dataset causes a limit value for a maximum allowable monetary value, in particular per time unit, to be exceeded and the requested de-anonymization is rejected by the corresponding terminal.

In one aspect of the invention, a payment system for exchanging monetary values is provided with a monitoring layer with a preferably decentrally controlled database, known as Distributed Ledger Technology, DLT, in which masked electronic coin datasets are stored; and a direct transaction layer, with at least two terminals, in which the method described above may be performed; and/or an issuer entity for generating an electronic coin dataset. In this regard, the issuer entity can prove that the masked generated electronic coin dataset was generated by it, preferably the issuer entity can identify itself by the signing and the monitoring entity can check the signature of the issuer entity.

In a preferred embodiment, the payment system comprises an issuer entity for generating an electronic coin dataset. In doing so, the issuer entity can prove that the masked generated electronic coin dataset was generated by it, preferably the issuer entity can identify itself by the signing and the monitoring entity can check the signature of the issuer entity.

Preferably, the payment system is designed for performing the above method and/or at least one of the embodiment variants.

A further aspect of the invention relates to a currency system comprising an issuer entity, a monitoring entity, a first terminal and a second terminal, wherein the issuer entity is designed to create an electronic coin dataset. The masked electronic coin dataset is designed to be detectably created by the issuer entity. The monitoring entity is configured to carry out a registration step as carried out in the above method. Preferably, the terminals, i.e. at least the first and second terminals, are suitable for carrying out one of the aforementioned methods for transmitting.

In a preferred embodiment of the currency system, only the issuer entity is authorized to initially create an electronic coin dataset. Processing, for example the step of connecting, splitting and/or switching, can be and preferably is performed by a terminal. The processing step of deactivating can preferably only be performed by the issuer entity. Thus, only the issuer entity would be authorized to invalidate the electronic coin dataset and/or the masked electronic coin dataset.

Preferably, the monitoring entity and the issuer entity are arranged in a server instance or are present as a computer program product on a server and/or a computer.

An electronic coin dataset in this case can be present in a plurality of different manifestations and thus be exchanged via different communication channels, hereinafter also referred to as interfaces. A very flexible exchange of electronic coin datasets is thus created.

The electronic coin dataset can be represented in the form of a file, for example. A file consists of data that belong together in terms of content and that are stored on a data carrier, data memory or storage medium. Each file is initially a one-dimensional string of bits that are normally interpreted as a group of byte blocks. An application program (application) or an operating system itself interprets this bit or byte sequence as, for example, a text, an image or a sound recording. The file format used for this can be different, for example it can be a pure text file representing the electronic coin dataset. In particular, the monetary value and the blind signature are represented as a file.

For example, the electronic coin dataset is a sequence of American Standard Code for Information Interchange, or ASCII, characters. In particular, in this case, the monetary value and the blind signature are represented as this sequence.

The electronic coin dataset can also be converted from one form of representation to another form of representation in a device. For example, the electronic coin dataset can be received as a QR code in the device and output as a file or string from the device.

These different forms of representation of one and the same electronic coin dataset allow a very flexible exchange between devices of different technical equipment using different transmission media (air, paper, wired) and taking into consideration the technical design of a device. The choice of the form of representation of the electronic coin datasets is preferably made automatically, for example on the basis of recognized or negotiated transmission media and device components. In addition, a user of a device can also select the form of representation for exchanging (=transmitting) an electronic coin dataset.

In one aspect of the invention, the object is solved by a device configured to directly transmit electronic coin datasets to another device. The device comprises means for accessing a data memory, the data memory having at least one electronic coin dataset stored therein; an interface for at least outputting the at least one electronic coin dataset to the other device; and a computing unit configured to mask the electronic coin dataset in the device by applying an encryption function, for example a homomorphic encryption function as a one-way function, to the electronic coin dataset in order to obtain a masked electronic coin dataset; linking the masked electronic coin dataset with a pseudonym in order to obtain a pseudonymized masked electronic coin dataset; and registering the masked electronic coin dataset in a monitoring entity; and outputting the electronic coin dataset by means of the interface.

In this context, a device is a previously described terminal or a previously described machine.

In a simple case, the data memory is an internal data memory of the device. This is where the electronic coin datasets are stored. Easy access to electronic coin datasets is thus ensured.

The data memory is in particular an external data memory, also called online memory. Thus, the device has only one means of accessing the coin datasets stored externally and thus securely. In particular, if the device is lost or malfunctions, the electronic coin datasets are not lost. Since possession of the (non-masked) electronic coin datasets equals possession of the monetary value, money can be stored more securely by using external data memories.

If the monitoring entity is a remote monitoring entity, the device preferably interfaces for communication by a common internet communication protocol, for example TCP, IP, UDP or HTTP. The transmission may include communication over the cellular network.

In a preferred embodiment, the device is configured to perform the processing operations already described, in particular splitting, connecting and switching, on an electronic coin dataset. For this purpose, the computing unit is arranged to mask an electronic coin dataset to be switched as the electronic coin dataset and to link it to a pseudonym that the monitoring entity needs as the masked electronic coin dataset for registering the switch command or in the switching step. In this way, an electronic coin dataset—as described above—can be switched.

Furthermore or alternatively, the computing unit is preferably arranged to mask an electronic coin dataset split into a number of coin subdatasets and to link them with a pseudonym in order to obtain a masked electronic coin dataset and possibly masked electronic coin datasets that can be registered in the monitoring entity. In this way, an electronic coin dataset—as described above—can be split.

Furthermore or alternatively, the computing entity is preferably configured to mask an electronic coin dataset to be connected from a first and a second electronic coin dataset as the electronic coin dataset and to link it with a pseudonym in order to obtain a masked coin dataset to be connected as the masked electronic coin dataset to be registered in the monitoring entity. In this way, an electronic coin dataset—as described above—can be connected.

In a preferred embodiment, the interface for outputting the at least one electronic coin dataset is an electronic display unit of the device, which is configured for displaying the electronic coin dataset and thereby (also) for outputting the electronic coin dataset in visual form. As has already been described, the electronic coin dataset is then interchangeable between devices, for example in the form of an optoelectronically detectable code, an image, etc.

In a preferred embodiment, the interface for outputting the at least one electronic coin dataset is a protocol interface for wirelessly sending the electronic coin dataset to the other device by means of a wireless communication protocol. In particular, near-field communication, for example by means of Bluetooth protocol or NFC protocol or IR protocol, is provided; alternatively or additionally, WLAN connections or mobile radio connections are conceivable. The electronic coin dataset is then adjusted according to the protocol properties and transmitted.

In a preferred embodiment, the interface for outputting the at least one electronic coin dataset is a data interface for providing the electronic coin dataset to the other device by means of an application. In contrast to the protocol interface, the electronic coin dataset is in this case transmitted by an application. This application then transmits the coin dataset in a corresponding file format. A file format specific to electronic coin datasets can be used. In its simplest form, the coin dataset is transmitted as an ASCII string or as a text message, for example SMS, MMS, instant messenger message (such as Threema or WhatsApp). In an alternative form, the coin dataset is transmitted as an APDU string. A wallet application may also be provided. In this case, the exchanging devices preferably ensure that an exchange is possible by means of the application. i.e. that both devices have the application and are ready for exchange.

In a preferred embodiment, the device further has an interface for receiving electronic coin datasets.

In a preferred embodiment, the interface for receiving the at least one electronic coin dataset is an electronic capture module of the device, configured for detecting an electronic coin dataset presented in visual form. The capture module is then, for example, a camera or a barcode or QR code scanner.

In a preferred embodiment, the interface for receiving the at least one electronic coin dataset is a protocol interface for wirelessly receiving the electronic coin dataset from another device by means of a communication protocol for wireless communication. In particular, a near-field communication, for example by Bluetooth protocol or NFC protocol or IR protocol is provided. Alternatively or additionally, WLAN connections or mobile connections are conceivable.

In a preferred embodiment, the interface for receiving the at least one electronic coin dataset is a data interface for receiving the electronic coin dataset from the other device by means of an application. This application then receives the coin dataset in a corresponding file format. A file format specific to coin datasets can be used. In its simplest form, the coin dataset is transmitted as an ASCII string or as a text message, for example SMS, MMS, Threema or WhatsApp. In an alternative form, the coin dataset is transmitted as an APDU string. Additionally, the transmission can be done by a wallet application.

In a preferred embodiment, the interface for receiving the at least one electronic coin dataset is also the interface for outputting the electronic coin dataset, such that an interface is provided for both sending and receiving the coin dataset.

In a preferred embodiment, the device comprises at least one security element reader arranged to read a security element; a random number generator; and/or a communication interface to a vault module and/or banking institution with access, which is to be authorized, to a bank account.

In a preferred embodiment, the data memory is a shared data memory accessible by at least one other terminal, each of the terminals having an application, the application being arranged to communicate with the monitoring entity for registering electronic coin records accordingly.

Thus, what is proposed here is a solution that issues digital money in the form of electronic coin datasets, which is modelled on the use of conventional (analogue) banknotes and/or coins. The digital money is represented here by electronic coin datasets. As with (analogue) banknotes, these electronic coin datasets will be usable for all forms of payments, including peer-to-peer payments and/or POS payments. Knowledge of all the components (in particular monetary value and concealment value) of a valid electronic coin dataset is tantamount to possession (ownership) of the digital money. It is therefore advisable to keep these valid electronic coin datasets confidential, e.g. to store them in a security element/vault module of a terminal and process them there. In order to decide on the authenticity of an electronic coin dataset and to prevent duplicate issues, masked electronic coin datasets are kept in the monitoring entity as a unique corresponding public representation of the electronic coin dataset. Knowledge or possession of a masked electronic coin dataset does not constitute possession of money. Rather, it is akin to checking the authenticity of the analogue means of payment.

The monitoring entity also comprises markings on performed and planned processings of the masked electronic coin dataset. A status of the respective masked electronic coin dataset is derived from the processing markings, indicating whether the corresponding (non-masked) electronic coin dataset is valid, i.e. ready for payment. Therefore, a recipient of an electronic coin dataset will first generate a masked electronic coin dataset and have the monitoring entity authenticate the validity of the masked electronic coin dataset. A major advantage of this solution according to the invention is that the digital money is distributed to terminals, merchants, banks and other users of the system, but no digital money or further metadata is stored at the monitoring entity—thus a common entity.

The proposed solution can be integrated into existing payment systems and infrastructures. In particular, there can be a combination of analogue payment transactions with notes and coins and digital payment transactions according to the present solution. Thus, a payment transaction can be made with banknotes and/or coins, but the change or change back is present as an electronic coin dataset. For example, ATMs with a corresponding configuration, in particular with a suitable communication interface, and/or mobile terminals can be provided for the transaction. Furthermore, a conversion of the electronic coin dataset into banknotes or coins is conceivable.

The steps of creating, switching, splitting, connecting and deactivating mentioned here are each triggered by a corresponding create, switch, split, connect or deactivate command.

### BRIEF SUMMARY OF THE FIGURES

In the following, the invention or further embodiments and advantages of the invention will be explained in more detail on the basis of figures wherein the figures merely describe embodiments of the invention. Identical components in the figures are given the same reference signs. The figures are not to be regarded as true to scale and individual elements of the figures may be shown in exaggeratedly large or exaggeratedly simplified form.

The figures show:

FIG. 1 an embodiment example of a payment system according to the invention;

FIG. 2 an embodiment example of a monitoring entity;

FIG. 3 an embodiment example of a payment system according to the invention for splitting and switching electronic coin datasets;

FIG. 4 an embodiment of a payment system according to the invention for connecting electronic coin datasets;

FIG. 5 an embodiment example of a method flow chart of a method according to the invention and corresponding processing steps of a coin dataset;

FIG. 6 an embodiment example of a method flow chart of a method according to the invention and corresponding processing steps of a coin dataset:

FIG. 7 a further embodiment example of a method flow chart of a method according to the invention;

FIG. 8 an embodiment example of a device according to the invention:

FIG. 9 an embodiment example of a sequence of payment processes according to the invention with monitoring of the monetary values per terminal; and

FIG. 10 an embodiment example of a sequence of a range confirmation according to the invention.

### FIGURE DESCRIPTION

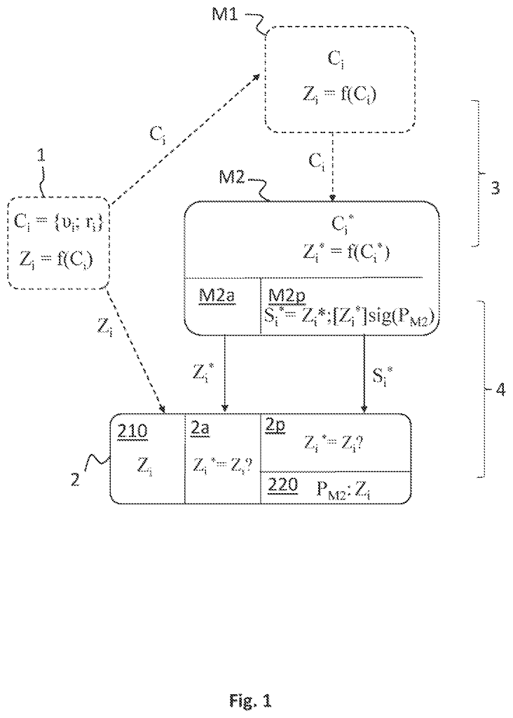

FIG. 1 shows an embodiment example of a payment system with terminals M1 and M2, an issuer entity 1 and a monitoring entity 2. The terminals M1 and M2 can also be devices.

In the issuer entity 1, for example a central bank, an electronic coin dataset Cᵢ is generated. A masked electronic coin dataset Zᵢ is generated for the electronic coin dataset Cᵢ, which is registered in the monitoring entity 2. The monitoring entity 2 includes a register 210 in which the valid masked electronic coin dataset Zᵢ is stored. The electronic coin dataset Cᵢ represents a monetary value vᵢ). The electronic coin dataset Cᵢ is issued to a first terminal M1. Electronic coin datasets Cᵢ, preferably for which a masked electronic coin dataset Zᵢ is registered, can be used for payment. The masked electronic coin dataset Zᵢ can also be referred to as a value-masked electronic coin dataset since the monetary value vᵢ is unknown to the monitoring entity 2 (and remains unknown in the further course). A recipient, for example a further terminal, of the electronic coin dataset Cᵢ can check its validity with the help of the monitoring entity 2. The monitoring entity 2 can confirm the validity of the electronic coin dataset Cᵢ using the masked electronic coin dataset Zᵢ. For the monitoring entity 2, the masked electronic coin dataset Zᵢ is an anonymous electronic coin dataset, in particular as it does not know an owner of the associated electronic coin dataset Cᵢ.

The first terminal M1 transmits the electronic coin dataset Cᵢ to a second terminal M2. The receiving second terminal M2 calculates a masked electronic coin dataset Zᵢ* for the received coin dataset C₁* (or a so-called modified coin dataset derived from it), the validity of which the monitoring entity 2 can confirm on the basis of the registered masked electronic coin datasets.

FIG. 1 shows that the second terminal M2 sends masked electronic coin datasets Zᵢ* anonymously to the monitoring entity 2 in an anonymous mode M2a. i.e. in particular only sends the masked electronic coin dataset Zᵢ*. The monitoring entity 2 processes the anonymously sent masked electronic coin dataset Zᵢ* in an anonymous mode 2a, in which, for example, the second terminal M2 is only confirmed that the sent masked electronic coin dataset Zᵢ* is valid.

The monitoring entity 2 stores in the register 210 anonymous (value)-masked coin datasets Zᵢ associated with newly generated electronic coin datasets Cᵢ of the issuer entity 1 or modified electronic coin datasets of the terminals.

FIG. 1 further shows that the second terminal M2 can now, according to the present solution, send masked electronic coin datasets Sᵢ* to the monitoring entity 2 also in a pseudonymized mode M2p. For example, the second terminal M2 links the masked electronic coin dataset Zᵢ* to a pseudonym P_{M2} and sends the pseudonymized masked electronic coin dataset Sᵢ* to the monitoring entity 2. The second terminal M2 could generate a pseudonymized masked electronic coin dataset Sᵢ* by appending the pseudonym P_{M2} to the masked electronic coin dataset Zᵢ*. In the embodiment shown, the second terminal M2 creates a signature over the masked electronic coin dataset Zᵢ* and adds the signature to the coin dataset Zᵢ*. For example, the public key of the signature key pair can serve as the pseudonym P_{M2}. Alternatively, however, a terminal number, such as IMEI, IMSI . . . , or a number derived from it can also be used as pseudonym P_{M2}.

The monitoring entity 2 processes the pseudonymously transmitted masked electronic coin dataset Sᵢ* in a pseudonymous mode 2p, in which it is also confirmed to the second terminal M2 that the transmitted masked electronic coin dataset Zᵢ* is valid. However, the association of the masked electronic coin dataset Zᵢ with the pseudonym P_{M2} is additionally stored in a data structure 220 of the monitoring entity 2. As will become clear in the further embodiments, the data structure 220 may be used as a register for masked electronic coin datasets Zᵢ yet to be checked. In pseudonymous mode 2p, the monitoring entity 2 in particular postpones or skips a checking step (more frequently or always) performed in anonymous mode 2a. The checking step preferably checks—further in ignorance of the monetary value vᵢ—whether the monetary value vᵢ of the masked electronic coin dataset Zᵢ is in an range.

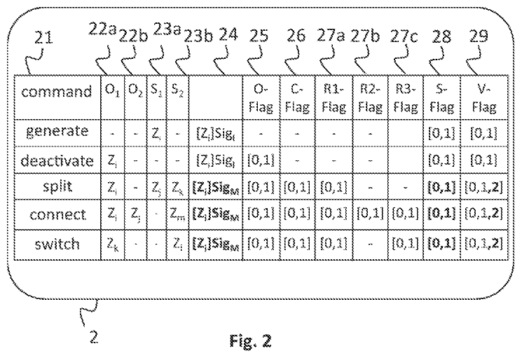

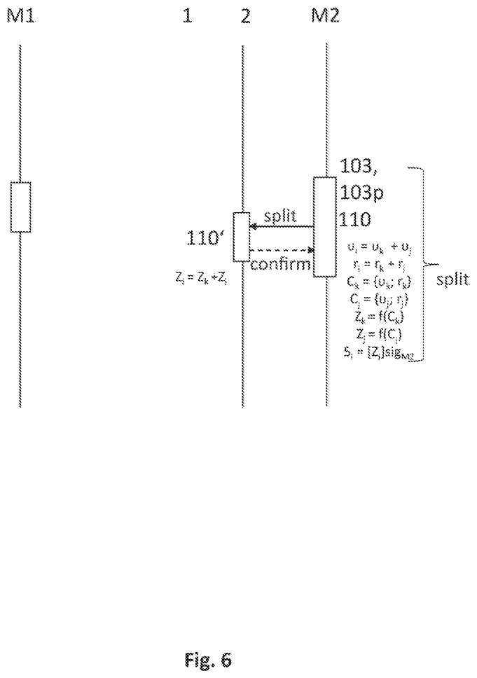

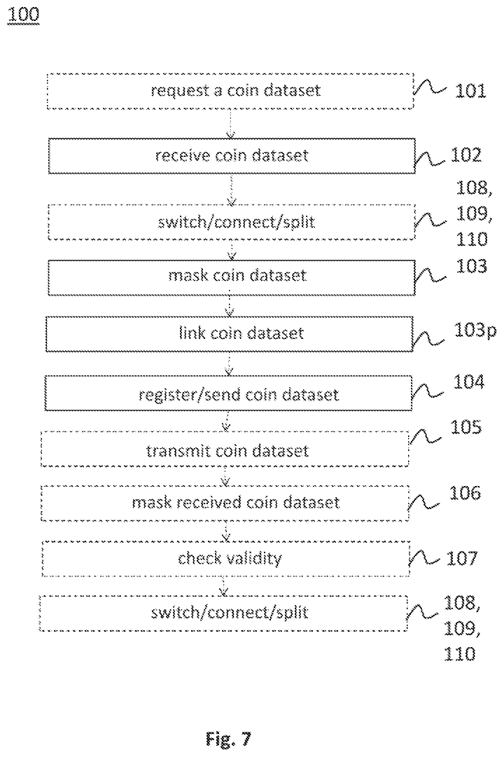

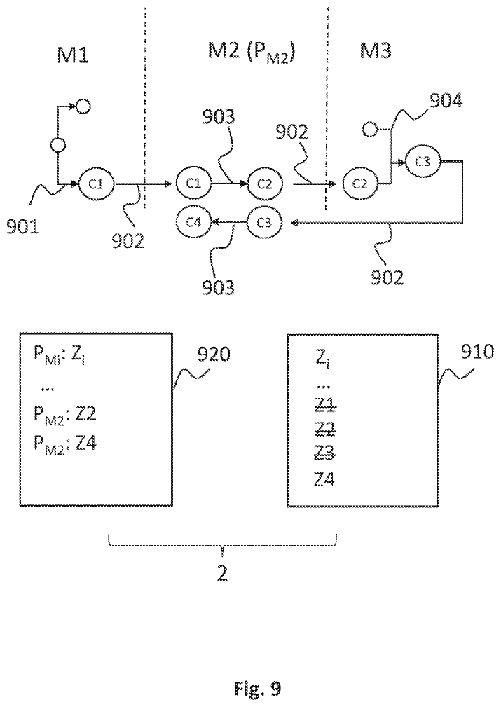

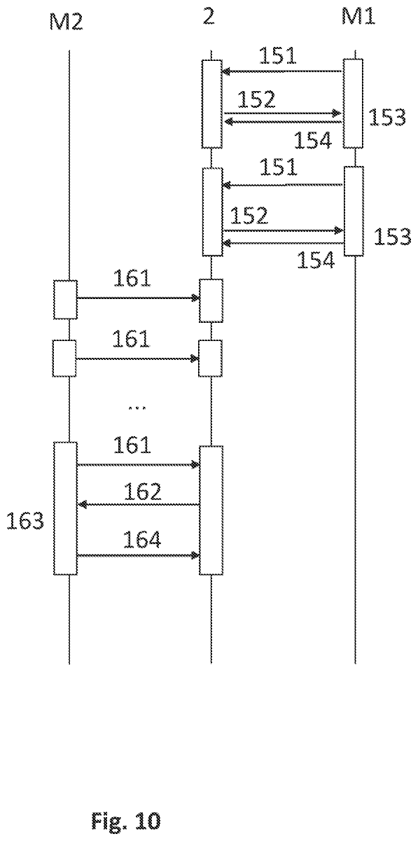

Further details of a preferred embodiment are now described for FIG. 1. The aspects described subsequently for FIGS. 2 to 7 are based at least in part on details of this embodiment. The more complex pseudonymous mode 2p or M2p is primarily described there, since the simpler anonymous mode 2a or M2a runs without a pseudonym (or signature). In contrast, FIGS. 9 and 10 describe embodiments that can only optionally be combined with the details of the other embodiments.

The monitoring entity may be an “concealed electronic dataset ledger”. In the context of the present invention, a ledger is understood to be a list, a directory, preferably a database structure.

For example, a true random number has been generated as an concealment value rᵢ. This concealment value rᵢ is linked to a monetary value vᵢ and then forms an i-th electronic coin dataset according to the invention:

Cᵢ={vᵢ;rᵢ} (1)

A valid electronic coin dataset can be used for payment. The possessor of the two values vᵢ and rᵢ is therefore in possession of the digital money. The digital money is represented in the overall system by a pair consisting of a valid electronic coin dataset Cᵢ and a corresponding masked electronic coin dataset Zᵢ. A masked electronic coin dataset Zᵢ is obtained by applying a one-way function f(Sᵢ) according to equation (2):

Zᵢ=f(Cᵢ) (2)

For example, the one-way function f(Cᵢ) is homomorphic. The function f(Cᵢ) is public, i.e. any system participant can invoke and use this function. This function f(Cᵢ) is defined according to equation (3) or equation (3a), for example:

Zᵢ=vᵢ·H+rᵢ·G (3)

Zᵢ=rᵢ·G (3a)

where H and G are generator points of a group G in which the discrete logarithm problem is hard, with the generators G and H for which the discrete logarithm of the other basis is unknown. For example, G (equation (3), (3a)) as well as H (equation (3)) are each a generator point of an elliptic curve cipher, ECC, —that is, private keys of the ECC. In the case of equation (3), these generator points G and H must be chosen in such a way that the context of G and H is not publicly known, so that if:

G=n·H (4)

the linking n must be practically undetectable in order to prevent the monetary value vᵢ from being manipulated and yet a valid Zᵢ could be calculated. Equation (3) is a “Pederson commitment for ECC”, which ensures that the monetary value vᵢ can be conceded, i.e. “committed”, to a monitoring entity 2 without revealing it to the monitoring entity 2. Therefore, only the masked coin dataset Zᵢ is sent (disclosed) to the public and remote monitoring entity 2.

Even though in the present example an encryption based on elliptic curves is described, another cryptographic method based on a discrete logarithmic method and based on equation (3a) would also be conceivable.

When equation (3a) is applied, a one-way function is applied only to a part of the coin dataset C, in this case the concealment value rᵢ this partially masked coin dataset can also be denoted as R.

Equation (3), through the entropy of the concealment value rᵢ, allows a cryptographically strong Zᵢ to be obtained even with a smaller range of values for monetary values vᵢ. Thus, a simple brute-force attack by merely estimating monetary values vᵢ is practically impossible.

Equations (3) and (3a) use one-way functions, which means that calculating Zᵢ from Cᵢ is easy because an efficient algorithm exists, whereas calculating Cᵢ starting from Zᵢ is very hard because no algorithm solvable in polynomial time exists.

Moreover, equation (3) is homomorphic for addition and subtraction, which means:

Zᵢ+Zᵢ=(vᵢ·H+rᵢ·G)+(vⱼ·H·rⱼ·G)=(vᵢ+vⱼ)·H+(rᵢ+rⱼ)·G (5)

Thus, addition operations and subtraction operations can be performed both in the direct transaction layer 3 and in parallel in the monitoring layer 4 without the monitoring layer 4 having knowledge of the electronic coin datasets Cᵢ. The homomorphic property of equation (3) allows monitoring of valid and invalid electronic coin datasets Cᵢ to be performed on the basis of the masked coin datasets Zᵢ alone and to ensure that no new monetary value vᵢ has been created.

This homomorphic property allows the coin dataset Cᵢ to be divided according to equation (1) into:

Cᵢ=Cⱼ+Cₖ={vⱼ;rⱼ}+{vₖ;rₖ} (6)

wherein:

vᵢ=vⱼ+vₖ (7)

rᵢ=rⱼ+rₖ (8)

For the corresponding masked coin datasets:

Zᵢ=Zⱼ+Zₖ (9)

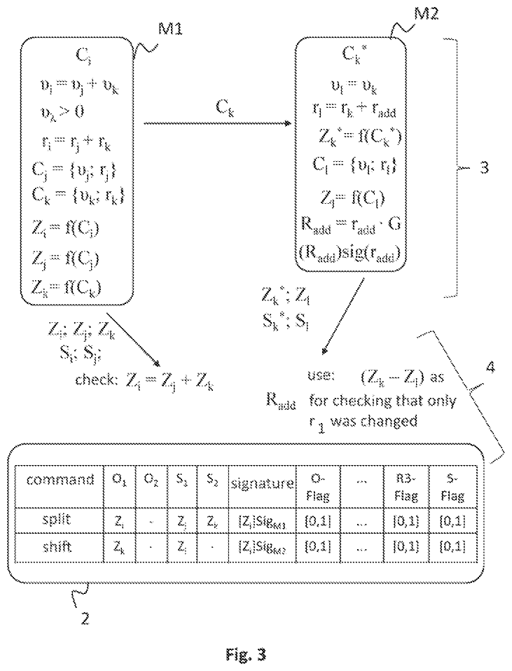

Equation (9), for example, can be used to easily check an asymmetric split processing or an asymmetric split processing step of a coin dataset according to FIG. 3 without the monitoring entity 2 having knowledge of Cᵢ, Cⱼ, Cₖ. In particular, the condition of equation (9) is checked to validate split coin datasets Cⱼ and Cₖ and invalidate coin dataset Cᵢ. Such splitting of an electronic coin dataset Cᵢ is shown in FIG. 3.

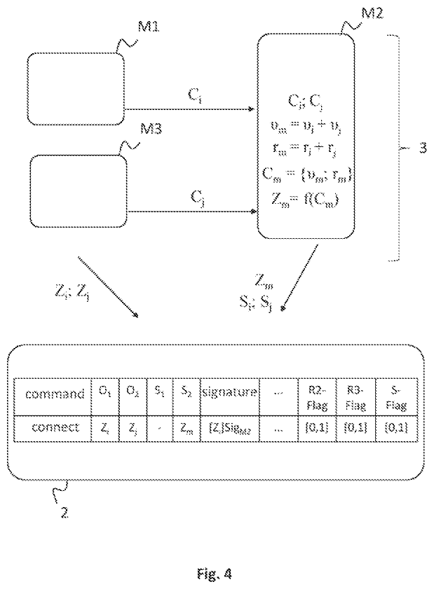

In the same way, electronic coin datasets can also be merged (connected), see FIG. 4 and the explanations thereto.

In the present case, the coin dataset is signed after masking in order to link a pseudonym of a terminal with the masked coin dataset. The signing is done in particular with a private signature key SK of a PKI key of the respective terminal Mₓ. The public part of the signature key can serve as the pseudonym P_{M2}. This signature is added to the masked coin dataset Zᵢ, see equation (3a):

Sᵢ=Zᵢ; [Zᵢ]sig(SK_{Mx}) (3a)

In addition, it is necessary to check whether non-allowed high or negative monetary values are registered. A possessor of an electronic coin dataset Cᵢ shall be able to prove to the monitoring entity 2 that all monetary values vᵢ in a processing operation are within a value range [0, . . . , n] without informing the monitoring entity 2 of the monetary values vᵢ. These range proofs are also called “Range-Proofs”. Ring signatures are preferably used as range proofs. For the present embodiment example, both the monetary value v and the concealment value r of an electronic coin dataset C are resolved in bit representation. It holds:

vᵢ=Σaⱼ·2^{j} for 0≤j≤n and aⱼ∈{0;1} (9a)

as well as

rᵢ=Σbⱼ·2^{j} for 0≤j≤n and bⱼ∈{0;1} (9b)

For each bit, preferably a ring signature with

Cᵢⱼ=aⱼ·H+bⱼ·G (9c)

and

Cᵢⱼ−aⱼ·H (9d)

whereby in one embodiment it can be provided that a ring signature is only performed for certain bits.

The monitoring entity 2 can request each terminal Mₓ to provide a range proof. This does not necessarily relate to a single transaction, as shown in equations 9a to 9d, but can comprise multiple transactions, for example by adding a “time unit” dimension. It would then have to be checked whether the sum of all transactions per time unit, here per day, exceeds a threshold value, see equation (9e):

v_{day}=Σvᵢ∈[0;v_{day}]≤v_{threshold value}? (9e)

In FIG. 1, an electronic coin dataset Cᵢ is generated by the issuer entity 1 and a masked electronic coin dataset Zᵢ is calculated by the issuer entity 1 by means of equation (3) or equation (3a) and this is registered in the monitoring entity 2. Subsequently, the first terminal M1 transmits the electronic coin dataset Cᵢ to a second terminal M2 or carries out one of the processing steps (switching, connecting, splitting). The transmission occurs wirelessly via WLAN, NFC or Bluetooth, for example. The transmission can be additionally secured by cryptographic encryption methods, for example by negotiating a session key or applying a PKI infrastructure.

In the second terminal M2, the transmitted electronic coin dataset Cᵢ is received as Cᵢ*. Upon receiving the electronic coin dataset Cᵢ*, the second terminal M2 is in possession of the digital money represented by the electronic coin dataset Cᵢ*. If both terminals trust each other, no further steps are necessary to complete the method. However, the terminal M2 does not know whether the electronic coin dataset Cᵢ* is actually valid. Moreover, the terminal M1 could still transmit the electronic coin dataset Cᵢ to a third terminal (not shown). To prevent this, further preferred steps in the method are provided.

To check the validity of the received electronic coin dataset Cᵢ*, the masked transmitted electronic coin dataset Zᵢ* is calculated in the second terminal M2 using the—public—one-way function from equation (3) or equation (3a). In addition—only in pseudonymous mode—a signature is calculated and appended according to equation (3a). The pseudonymized masked transmitted electronic coin dataset Sᵢ* is then transmitted to the monitoring entity 2. If the masked transmitted electronic coin dataset Zᵢ* matches a registered and valid masked electronic coin dataset, the validity of the received coin dataset Cᵢ* is displayed to the second terminal M2 and it is deemed that the received electronic coin dataset Cᵢ* is equal to the registered electronic coin dataset Cᵢ. In one embodiment, the check for validity can be used to determine that the received electronic coin dataset Cᵢ* is still valid, i.e. that it has not already been used by another processing step or in another transaction and/or has not been subject to a further modification.

Preferably, a switching of the received electronic coin dataset occurs thereafter.

It holds for the method according to the invention that the sole knowledge of a masked electronic coin dataset Zᵢ or signed masked electronic coin dataset Sᵢ does not entitle to spend the digital money. However, the sole knowledge of the electronic coin dataset Cᵢ entitles to pay, i.e. to perform a transaction successfully, in particular if the coin dataset Cᵢ is valid. There is a one-to-one relationship between the electronic coin datasets Cᵢ and the corresponding masked electronic coin datasets Zᵢ. The masked electronic coin datasets Zᵢ or the signed masked electronic coin datasets Sᵢ, are registered in the monitoring entity 2, for example a public decentral database. In the embodiment according to FIG. 1, both anonymous and pseudonymously obtained masked electronic coin datasets Zᵢ are stored in the data structure 210. The pseudonymously masked electronic coin dataset Sᵢ (or with association to the coin dataset Zᵢ, the pseudonym or signature) is stored in the data structure 220. This registration first makes it possible to check the validity of the electronic coin dataset Zᵢ, for example whether new monetary values have been created (illegally). Furthermore, together with pseudonymization of the masked coin dataset, it becomes possible to associate a transaction to a pseudonym of a terminal Mₓ.

A main distinguishing feature compared to conventional solutions is that the masked electronic coin dataset Zᵢ or the signed masked electronic coin dataset Sᵢ is stored in a monitoring layer 4 and all processing on the electronic coin dataset Sᵢ, Zᵢ is registered there, whereas the actual transmission of the digital money takes place in a (secret, i.e. not known to the public) direct transaction layer 3.

In order to prevent multiple spending or to ensure more flexible transmission, the electronic coin datasets can now be processed in the method according to the invention. The following table 1 lists the individual operations, whereby a corresponding processing step is also carried out with the specified command:

TABLE 1
Number of operations that can be performed per processing of a
coin dataset in the terminal or issuer entity;

| Command or | Create | Create random | | Create range |
|---|---|---|---|---|
| step | signature | number | Create masking | proof |
| Generate | 1 | 1 | 1 | 0 or 1 |
| Deactivate | 1 | 0 | 1 | 0 or 1 |
| Split | 1 | 1 | 3 | 0 or 1 |
| Connect | 1 | 0 | 3 | 1 |
| Switch | 1 | 1 | 2 | 1 |

Further operations not listed in table 1 may be required. Instead of the listed implementation, other implementations are also conceivable that imply other operations. Table 1 shows that, for each coin dataset, each of the operations “Create”. “Deactivate”. “Split”, “Connect” and “Switch”, different operations “Create signature”; “Create random number”; “Create masking”; “Range check” may be provided, each of the processing operation being registered in the monitoring entity 2 and appended there in invariant form to a list of previous processing operations for masked electronic coin datasets Zᵢ. The operations of creating and deactivating an electronic coin dataset are carried out only at secure locations and/or only by selected entities, for example the issuer entity 1, while the operations of all other processing operations can be carried out on the terminals M1 to M3.

The number of operations for the individual processings is marked with “0”, “1” or “2” in table 1. The number “0” indicates that the terminal or the issuer entity 1 does not have to perform this operation for this processing of the electronic coin dataset. The number “1” indicates that the terminal or issuer entity 1 must be able to perform this operation once for this processing of the electronic coin dataset. The number “2” indicates that the terminal or the issuer entity 1 must be able to perform this operation twice for this processing of the electronic coin dataset.

In principle, it can also be provided in one embodiment that a range check is also performed by the issuer instance 1 upon creating and/or deleting.

Table 2 below lists the operations required for the monitoring entity 2 for the individual processing operations:

TABLE 2
Number of operations that can be performed per processing of a coin dataset
in the monitoring entire;

| | | | | | Comprehend |
|---|---|---|---|---|---|
| | | | | | homomorphous |
| | | | | | properties of the |
| | | | Check validity | | masked electronic |
| | | Check | of the masked | | coin datasets, i.e. |
| Command or | Check signature | signature of | electronic coin | Comprehend | adding or |
| step | of issuer | terminal | dataset | range proof | substracting |
| Generate | 1 | 0 | 0 | 0 or 1 | 0 |
| Deactivate | 1 | 0 | 1 | 0 or 1 | 0 |
| Split | 0 | 1 | 1 | 2 or more | 1 |
| Connect | 0 | 1 | 2 or more | 1 | 1 |
| Switch | 0 | 1 | 1 | 1 | 0 |

Further operations not listed in table 2 may be required. Instead of the listed implementation, other implementations are conceivable that imply other operations. All operations of table 2 can be performed in the monitoring entity 2, which is a trusted entity, for example a decentral server, in particular a distributed trusted server, that ensures sufficient integrity of the electronic coin datasets. The monitoring entity 2 has a public verification key to check the signature of the signed masked coin dataset S. The public verification key may serve as a pseudonym or be associated with a pseudonym. The pseudonymized masked coin dataset S comprises at least the coin dataset Z and directly or indirectly the pseudonym, indirectly for example as part of the signature.

Table 3 shows the preferred components to be installed for the system participants in the payment system of FIG. 1:

TABLE 3
Preferred units in the system components.

| Command or step | Issuer entity | Terminal | Monitoring entity |
|---|---|---|---|
| Random number generator | Yes | — | — |
| (high security) | | | |
| Random number generator | — | Yes | — |
| (deterministic) | | | |
| PKI for signing | Yes | Yes | — |
| PKI for signature verification | — | (Yes) | Yes |
| Read access to DLT | Yes | Yes | Yes |
| Write access to DLT | Yes | Yes | Yes |
| Disabling the electronic | Yes | Yes | — |
| coin dataset | | | |
| Transport encryption | Yes | Yes | — |
| Secure memory | (Yes) | Yes | —/Yes |
| Masking unit | Yes | Yes | — |
| Range proof | — | Yes | — |
| Check range proof | — | — | Yes |
| DLT software | — | — | Yes |

Table 3 shows an overview of the preferred components to be used in each system participant. i.e. the issuer entity 1, a terminal M1 and the monitoring entity 2. The terminal M1 can be used as a wallet for electronic coin datasets Cᵢ, i.e. designed as an electronic wallet, thus a data memory of the terminal M1, in which a plurality of coin datasets Cᵢ may be stored, and may be implemented, for example, in the form of an application on a smartphone or IT system of a trader, a commercial bank or another market participant and send or receive an electronic coin dataset. Thus, the components are implemented as software in the terminal as shown in Table 3. It is assumed that the monitoring entity 2 is based on a DLT and operated by a number of trusted market participants.

FIG. 2 shows an embodiment example of a monitoring entity 2 that could also be used in FIG. 1. FIG. 2 shows an exemplary database in the form of a table in which the masked electronic coin datasets Zᵢ and, if applicable, their processings are registered. The monitoring entity 2 is preferably arranged locally remote from the terminals M1 to M3 and is accommodated, for example, in a server architecture.

Each processing operation for a processing (creating, deactivating, splitting, connecting and switching) is registered in the monitoring entity 2 and appended there, for example in unchangeable form, to a list of previous processing operations for masked electronic coin datasets Zᵢ. The individual operations or their check results, thus so to say the intermediate results of a processing operation, are recorded in the monitoring entity 2. Although a continuous list is assumed in the following, this data structure can also be cleaned or compressed, if necessary according to predetermined rules, or provided separately in a cleaned or compressed form.

The processings “create” and “deactivate”, which concern the existence of the monetary value vᵢ, per se, thus imply the creation and destruction of money, require an additional authorization by the issuer entity 1 in order to be registered (thus logged) in the monitoring entity 2. The other processing operations (splitting, connecting, switching) do not require authorization by issuer instance 1 or by the command initiator (=payer, e.g. the first terminal M1). However, the other processing operations must be checked with regard to various check criteria.

A registration of the respective processing in the monitoring entity 2 is realized, for example, by corresponding list entries in the database according to FIG. 2. Each list entry has further markings 25 to 28 which document the intermediate results of the respective processing which must be performed by the monitoring entity 2. Preferably, the markings 25 to 28 are used as an aid and are discarded by the monitoring entity after completion of the commands. For anonymous coin datasets, all checks must always be carried out so that all markings 25-28 could also be discarded. For pseudonymized coin datasets, on the other hand, a check can be omitted or carried out later. In FIG. 2, for example, the checks corresponding to the markings 27b and 27c are not necessary for pseudonymized coin datasets because they are performed later in a different form. The checking steps of the markings 25, 26, 27a and 28, on the other hand, are necessary. In the following, we will refer in part to necessary or validity-relevant checking steps and to verifiable or validity-independent checking steps, since they are performed directly or indirectly at a later time. A coin dataset can be treated as valid if the necessary checks have been carried out.

The data in columns 24, 28 and 29 highlighted in bold in FIG. 2 are only relevant for coin datasets received pseudonymized.

An optional marking 29 can, for example, indicate the completion of the processing. Markings 29 are in “-” state when a processing command is received, for example, and are set to “1” state after all checks have been successfully completed (to markings 25-28) and are set to “0” state if at least one check has failed. A (completion) marking 29 with the value “2” could, for example, indicate that only the necessary examinations were completed and that examinations that could be caught up were omitted. If checks for one or a plurality of entries are caught up by the terminal with the pseudonym, the marking can be set to the value “1”. Instead of using the completion marking 29 in this way, the markings 27b and 27c of the checks to be caught up could of course also be used and/or a separate pseudonym marking could be used.

For example, a possible structure for a list entry of a coin dataset comprises two columns 22a, 22b for a predecessor coin dataset (O1, O2), two columns 23a. 23b for a successor coin dataset (S1, S2), a signature column 24 for signatures of issuer entity/entities 1 and signatures of terminals M, and six marking columns 25, 26, 27a, 27b and 27c and 28. Each of the entries in columns 25 to 28 has three alternative states, “-”, “1” or “0”.

Column 25 (O-Flag) indicates whether a validity check was successful with regard to a predecessor electronic coin dataset in column 22a/b. The “1” state indicates that a validity check revealed that the column 22a/b electronic coin dataset is valid and the “0” state indicates that a validity check revealed that the column 22a/b electronic coin dataset is invalid and the “-” state indicates that a validity check has not yet been completed. For multiple predecessor coin datasets, it is preferred to use a combined O-Flag (both valid) rather than two separate O-Flags. Column 26 (C-Flag) indicates whether an initial check calculation was successful for the masked electronic coin datasets. The first check calculation checks in particular whether the command is value-neutral, i.e. primarily that the sum of the monetary values involved is zero. The “I” state means that a calculation was successful and the “0” state indicates that calculation was not successful and the “-” state indicates that a calculation has not yet been completed.

For example, the calculation to be performed in column 26 based on equation (3) is:

(Z_{O1}+Z_{O2})−(Z_{S1}+Z_{S2})==0 (10)

Column 27a (R1-Flag) indicates whether a first check of a range proof or of the range proof was successful. The same applies to the further columns 27b (R2-Flag) and 27c (R3-Flag). The “1” state means that a validity check showed that the range proofs or the range proof could or is comprehensible and the “0” state indicates that a validity check showed that the range proofs or the range proof could not be comprehended and the “-” state indicates that a validity check is not yet completed, was not successful. The first range proof of column 27a is always necessary for the coin dataset(s) to be considered valid. A typical example of a necessary check is the check that the monetary value is not negative (or none of the monetary values are negative). The second and third range proofs do not affect the validity of the coin dataset and can be performed later for pseudonymized masked coin datasets, for example in a later transaction of the pseudonym. The range proof of column 27b is used to check whether the monetary value of the masked coin dataset (or each coin dataset) is below a maximum value. The maximum value can be predetermined system-wide or for specific terminal types. For example, the range check of column 27c is used to compare a sum of monetary values (sent or) received by the terminal in a specific time period—such as 24 hours—against a sum limit value, or to check, for example, a transaction count per time unit for the terminal, such as a maximum of 5 per minute or 100 per day. The limit values can be predefined by the payment system system-wide or defined for specific terminal device types (thus terminal device-specific) (e.g.: Type X coffee machine can only dispense 4 portions of hot drinks per minute due to the device and accordingly only 4 transactions per minute are permitted).

Column 28 (S-Flag) indicates whether a signature of the electronic coin dataset matches the signature of column 24, where the “1” state indicates that a validity check revealed that the signature could be identified as that of the issuer entity and the “0” state indicates that a validity check revealed that the signature could not be identified as that of the issuer entity and “-” state indicates that a validity check is not yet completed.

A change in the status of one of the markings (also referred to as a “flag”) requires approval by the monitoring entity 2 and must then be stored unchangeably in the data structure. A processing is final in anonymous mode (or for an anonymous masked coin dataset) if and only if the required flags 25 to 28 have been validated by monitoring entity 2, i.e. changed from “0” state to “1” state or “1” state after the appropriate check. Processing is completed in pseudonymous mode (or for a pseudonymized masked coin dataset) when the checks for the markings 25 to 27a and 28 have been performed.

In the following, a data structure without completion markings 29 is assumed and the validity of anonymous coin datasets is considered first. In order to determine whether a masked electronic coin dataset Z is valid, the monitoring entity 2 searches for the last change that relates to the masked electronic coin dataset Z. It holds that the masked electronic coin dataset Z is valid if the masked electronic coin dataset Z is listed for its last processing in one of the successor columns 23a, 23b if and only if that last processing has the corresponding final marking 25 to 28. It further holds that the masked electronic coin dataset Z is valid if the masked electronic coin dataset Z is listed for its last processing in one of the predecessor columns 22a, 22b, if and only if this last processing has failed, thus at least one of the corresponding required states of the markings 25 to 28 is set to “0”.

If the masked electronic coin dataset Z is not found in the monitoring entity 2, it is invalid. It also holds that the anonymous masked electronic coin dataset Z is not valid for all other cases. For example, if the last processing of the masked electronic coin dataset Z is listed in one of the successor columns 23a, 23b but this last processing never became final or if the last processing of the masked electronic coin dataset Z is in one of the predecessor columns 22a, 22b and this last processing is final.

The checks performed by the monitoring entity 2 in order to determine whether a processing is final are represented by columns 25 to 28: The state in column 25 indicates whether the masked electronic coin dataset(s) are valid according to predecessor columns 22a, 22b. The state in column 26 indicates whether the calculation of the masked electronic coin dataset is correct according to equation (10). The state in column 27a indicates whether the range checks for the masked electronic coin dataset Z could be successfully checked. The state in column 28 indicates whether the signature in column 24 of the masked electronic coin dataset Z is a valid signature of issuer entity 1.

The “0” status in a column 25 to 28 indicates that the check was not successful. The “1” status in a column 25 to 28 indicates that the check was successful. The “-” state in a column 25 to 28 indicates that no check was performed. The states can also have a different value, as long as a clear distinction can be made between success/failure of a check and it is evident whether a certain check was performed.

As an example, five different processes are defined, which are explained in detail here. Reference is made in this case to the corresponding list entry in FIG. 2.

One processing is, for example, “generating” an electronic coin dataset Cᵢ. Generating in the direct transaction layer 3 by the issuer entity 1 involves selecting a monetary value vᵢ and creating an concealment value rᵢ, as described earlier with equation (1). As shown in FIG. 2, no entries/markings are required in columns 22a, 22b, 23b and 25 to 27 during the “Generate” processing. The masked electronic coin dataset Zᵢ is registered in the successor column 23a. This registration is preferably done before transmitting it to a terminal M1 to M3, in particular or already at the time of generation by the issuer entity 1, and in both cases equation (3) or equation (3a) must be executed for this purpose. The masked electronic coin dataset Zᵢ is signed by the issuer entity 1 when it is created, this signature is entered in column 24 in order to ensure that the electronic coin dataset Cᵢ has actually been created by an issuer entity 1, although other processes may also be used for this purpose. If the signature of a received Cᵢ matches the signature in column 24, the marking in column 28 is set (from “0” to “1”). The markings according to columns 25 to 27 do not require a status change and can be ignored. The range proof is not required because monitoring entity 2 trusts that issuer entity 1 will not issue negative monetary values. However, in an alternative execution, it can be sent by issuer entity 1 in the create command and checked by monitoring entity 2.

One processing is, for example, “deactivate”. Deactivating, thus destroying money (DESTROY), causes the masked electronic coin dataset Zᵢ to become invalid after successful execution of the deactivate command by issuer instance 1. One can therefore no longer process the (masked) electronic coin dataset to be deactivated in monitoring layer 4. To avoid confusion, the corresponding (non-masked) electronic coin datasets Cᵢ should also be deactivated in the direct transaction layer 3. Upon “deactivating”, the predecessor column 22a is written to with the electronic coin dataset Zᵢ, but no successor column 23a, 23b is occupied. The masked electronic coin dataset Zᵢ shall be checked during deactivation whether the signature matches the signature according to column 24 in order to ensure that the electronic coin dataset Cᵢ has indeed been created by an issuer entity 1, wherein again other means may be used for this check. If the signed Zᵢ sent in the deactivate command can be confirmed as signed by issuer instance 1 or confirmed as validly signed, marking 28 is set (from “0” to “1”). The markings according to columns 26 to 27 do not require a status change and can be ignored. The markings according to columns 25 and 28 are set after appropriate check.

One processing is, for example, “splitting”. The splitting, thus dividing of an electronic coin dataset Zᵢ into a number n, for example 2, of electronic coin subdatasets Zⱼ and Zₖ is first carried out in the direct transaction layer 3, as still shown in FIGS. 3, 5 to 7 and also FIGS. 9 to 11, whereby the monetary values vⱼ and the concealment value rⱼ are generated, vₖ and rᵢ result from equations (7) and (8). In monitoring entity 2, markings 24 to 27 are set, predecessor column 22a is described by electronic coin dataset Zᵢ, successor column 23a is described by Zⱼ and successor column 23b is described by Zₖ. The status changes required according to columns 24 to 27 are performed after the corresponding check by monitoring entity 2 and document the respective check result. The marking according to column 28 is ignored in particular in anonymous mode. A first range proof R1 according to column 27a must be provided, for example, to show that no monetary value is negative. A second range proof R2 in column 27b is not necessary because the successor monetary subvalues are always smaller than the initial monetary value of the predecessor. A sum range proof R3 in column 27c is also usually not necessary (no new monetary values). Column 24 is used to enter a signature generated by the splitting terminal M1 to M3.

For example, one processing is “connecting”. The connecting, thus merging of two electronic coin datasets Zᵢ and Zⱼ into one electronic coin dataset Zₘ is first performed in the direct transaction layer 3, as still shown in FIG. 4, where the monetary value vₘ and the concealment value rₘ are calculated. In the monitoring entity 2, the markings 25 to 28 are set, the predecessor column 22a is described with the electronic coin dataset Zᵢ, predecessor column 22b is described with Zⱼ and successor column 23b is described with Zₘ. The markings in columns 25 to 28 require status changes and the monitoring entity 2 performs the corresponding checks. A first range proof R1 according to column 27a must be provided to show that no new money has been generated. A second range check R2 in column 27b is useful because the new monetary value of the successor could be greater than a maximum value. A sum range proof R3 in column 27c is also usually useful, as the terminal could be using newly received predecessors. The marking according to column 28 can be ignored. Column 24 is used to enter a signature generated by the connecting terminal M1 to M3.

A further processing is, for example, “switching”. Switching is necessary when an electronic coin dataset has been transmitted to another terminal and double spending by the transmitting terminal (here M1) is to be excluded. Upon switching, the electronic coin dataset Cₖ received from the first terminal M1 is replaced by a new electronic coin dataset Cᵢ with the same monetary value. The new electronic coin dataset Cᵢ is generated by the second terminal M2. This switching is necessary to invalidate (make invalid) the electronic coin dataset Cₖ received from the first terminal M1, which avoids double spending of the same electronic coin dataset Cₖ. This is because, as long as the electronic coin dataset Cₖ is not switched, and since the first terminal M1 is aware of the electronic coin dataset Cₖ, the first terminal M1 can pass this electronic coin dataset Cₖ to a third terminal M3. The switching is done, for example, by adding a new concealment value r_{add} to the concealment value rₖ of the received electronic coin dataset Cₖ, thereby obtaining an concealment value rᵢ that only the second terminal M2 knows. This can also be done in the monitoring entity 2. To prove that only a new concealment value r_{add} has been added to the concealment value rt of the masked received electronic coin dataset Zₖ, but the monetary value has remained the same, and thus equation (11):

vₖ=vₗ (11)

holds, so that the second terminal M2 must be able to prove that Zₗ-Zₖ can be represented as a scalar multiple of G, thus as r_{add}*G. This means that only a concealment value r_{add} has been generated and the monetary value of Zᵢ is equal to the monetary value of Zₖ, i.e. Zₗ=Zₖ+r_{add}*G. This is done by generating a signature with the public key Zₗ-Zₖ=r_{add}*G. This signature is used in monitoring layer 4 to confirm the validity of the electronic coin dataset to be switched.

The “splitting” and “connecting” modifications to an electronic coin dataset can also be delegated from a terminal M1 to another terminal M2, M3, for example if a communication link to the monitoring entity 2 is not available.

FIG. 3 shows an embodiment example of a payment system according to the invention for “splitting”, “connecting” and “switching” electronic coin datasets C. In FIG. 3, the first terminal M1 has received the coin dataset Cᵢ and now wishes to perform a payment transaction not with the entire monetary value vᵢ, but only with a partial value vₖ. For this purpose, the coin dataset Cᵢ is split. To do this, the monetary value is split first:

vᵢ=vⱼ+vₖ (12)

For this, each of the received values vⱼ, vₖ, must be greater than 0, because negative monetary values are not allowed.

In addition, new concealment values are derived:

rᵢ=rⱼ+rₖ (13)

Upon splitting, masked coin datasets Zⱼ and Zₖ are obtained from the coin datasets Cⱼ and Cₖ according to equation (3) and registered in monitoring entity 2. For splitting, the predecessor column 22a is described with coin dataset Zᵢ, the successor column 23a with Zⱼ and the successor column 23b with Zₖ. Additional information for the range proof R1 (zero-knowledge-proof) is to be generated. The markings in columns 25 to 27c require status change and the monitoring entity 2 performs the corresponding checks. The marking according to column 28 is ignored.

Then, a coin subdataset, here Cₖ, is transmitted from the first terminal M1 to the second terminal M2. To prevent double spending, a switching operation is useful to exchange the electronic coin dataset Cₖ received from the first terminal M1 for a new electronic coin dataset Cᵢ with the same monetary value. The new electronic coin dataset Cᵢ is generated by the second terminal M2. The monetary value of the coin dataset Cₖ is taken over and not changed, see equation (11).

Then, according to equation (14), a new concealment value r_{add} is added to the concealment value rₖ of the received electronic coin dataset Cₖ.

rₗ=rₖ+r_{add} (14)

thereby obtaining a concealment value rᵢ known only to the second terminal M2. To prove that only a new concealment value r_{add} has been added to the concealment value rₖ of the received electronic coin dataset Zₖ, but that the monetary value has remained the same (vₖ=vₗ), the second terminal M2 must be able to prove that Zₗ-Zₖ can be represented as a multiple of G. This is done by means of the (public) signature R_{add} according to equation (15):

R_{add}=r_{add}·G=Zᵢ−Zₖ=(vₗ−vₖ)*H+(rₖ+r_{add}−rₖ)*G (15)

where G is the generator point of the ECC. Then the coin dataset Cᵢ to be switched is masked by equation (3) or equation (3a) to obtain the masked coin dataset Z₁. Then the masked coin dataset Zᵢ is signed by equation (3a) in order to obtain the signed coin dataset Sᵢ. In the monitoring entity 2, the private signature r_{add} can then be used, for example, to sign the masked electronic coin record Zᵢ to be switched, which is considered proof that the second terminal M2 has only added an concealment value r_{add} to the masked electronic coin dataset and not an additional monetary value, i.e. vᵢ=vₖ.

The signature is entered in the field of column 24. Here, as an example, it was assumed that the pseudonyms of the receiving terminals Mₓ are kept track of in monitoring entity 2. Then, upon “splitting”, the signature of the first terminal M1 is entered, since it has received the coin dataset Cᵢ. Then, upon “switching”, the signature of the second terminal M2 is entered, since it has received the coin dataset Cₖ. Alternatively, the pseudonyms of the sending terminals Mₓ could also be entered. Then the coin dataset Cₗ to be switched is masked by equation (3) in order to obtain the masked coin dataset Z₁. Then the masked coin dataset Zₗ is signed by equation (3a) to obtain the signed coin dataset Sₗ.

The proof for masking by means of equation (3) is as follows:

$${Z}_{k} = {v}_{k} \cdot H + {r}_{k} \cdot G \\ {Z}_{l} = {v}_{l} \cdot H + {r}_{l} \cdot G = {v}_{k} \cdot H + ( {r}_{k} + {r}_{add} ) \cdot G \\ {Z}_{l} - {Z}_{k} = ( {r}_{k} + {r}_{add} - {r}_{k} ) \cdot G \\ = {r}_{add} \cdot G \qquad ( 16 )$$

For masking by equation (3a), a signature is generated over the monetary value vₖ, the masking value rₖ and the masked coin dataset Z (also referred to as R). Thus, the signature can be validated by recalculating the masking in the monitoring entity 4 to be able to prove the authenticity and existence/possession of the coin dataset C.

FIG. 4 shows an embodiment example of a payment system according to the invention for connecting electronic coin datasets. Here, the two coin datasets Cᵢ and Cⱼ are obtained in the second terminal M2. Following the splitting according to FIG. 3, a new coin dataset Zₘ is now obtained by adding both the monetary values and the concealment value of the two coin datasets Cᵢ and Cⱼ. Then the obtained coin dataset Cₘ to be connected is masked by equation (3) or equation (3a) and the masked coin dataset Zₘ is registered in the monitoring entity. Then, when “connecting”, the signature of the second terminal M2 is entered, as it has received the coin datasets Cᵢ and C₃.

For masking by means of equation (3a), a first signature can be generated by the monetary value vᵢ, the concealment value rᵢ, and the masked coin dataset Zᵢ, and a second signature can be generated by the monetary value vⱼ, the concealment value rⱼ, and the masked coin dataset Zⱼ. Both signatures can be validated by recalculating the masking in the monitoring entity 4, respectively, in order to be able to prove the authenticity and the existence/possession of the coin dataset C. The first signature may also be linked with the second signature in order to form a common signature.

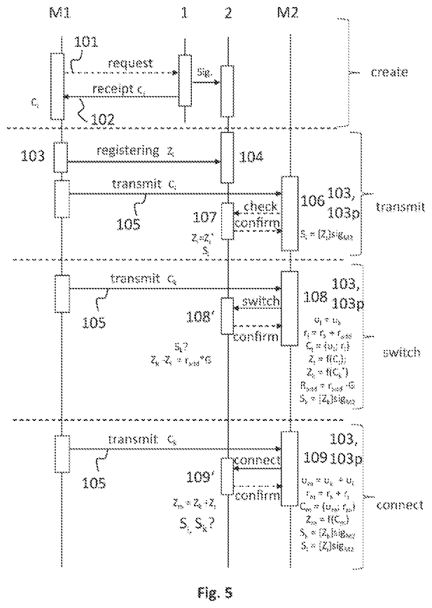

FIGS. 5 to 7 are each an embodiment example of a method flow diagram of a method 100. In the following, FIGS. 5 to 7 are explained in combination. In optional steps 101 and 102, a coin dataset is requested and provided by the issuer entity 1 to the first terminal M1 after creating the electronic coin dataset. A signed masked electronic coin dataset is sent to the monitoring entity 2 in step 103. In step 103, the obtained electronic coin dataset Cᵢ is masked according to equation (3) and signed in step 103p according to equation (3a) as explained in FIG. 1. Then, in step 104, the masked electronic coin dataset Zᵢ is registered in the monitoring entity 2. Optionally, M1 can switch the received electronic coin dataset, then a signature Sᵢ would be registered in the monitoring entity 2. In step 105, the coin dataset Cᵢ is transmitted in the direct transaction layer 3 to the second terminal M2. In the optional steps 106 and 107, a validity check with prior masking is performed, in which, in the good case, the monitoring entity 2 confirms the validity of the coin dataset Zᵢ or Cᵢ.

In the optional step 108, a received coin dataset Cₖ is then switched (of course, the received coin dataset Cᵢ could also be switched) to a new coin dataset Cₗ, whereby the coin dataset Cₖ becomes invalid and double spending is prevented. For this purpose, the monetary value vₖ of the transmitted coin dataset Cₖ is used as the “new” monetary value vₗ. In addition, as already explained with equations (14) to (17), the concealment value rₗ is created. The additional concealment value r_{add} is used to prove that no new money (in the form of a higher monetary value) was generated by the second terminal M2. Then the masked coin dataset is signed and the signed masked coin dataset Zᵢ to be switched is sent to the monitoring entity 2 and the switching from Cₖ to Cₗ is instructed. In addition, a signature Sₖ is created by the first or second terminal M1, M2 and stored in the monitoring entity 2. In addition or alternatively, a signature Sₗ could also be created and deposited in the monitoring entity 2 if sending terminals Mₓ were registered instead of receiving terminals Mₓ.

In step 108′, the corresponding check is carried out in monitoring entity 2. Here, Zₖ is entered in column 22a according to the table in FIG. 2 and the coin dataset Zₗ to be transferred is entered in column 23b. A check is then carried out in monitoring entity 2 as to whether Zₖ is (still) valid, thus whether the last processing of Zₖ is entered in one of the columns 23a/b (as proof that Zₖ has not been further split or deactivated or connected) and whether a check for the last processing has failed. In addition, Zₗ is entered in column 23b and the markings in columns 25, 26, 27 are initially set to “0”. Now a check is made whether Zₗ is valid, whereby the check according to equations (16) and (17) can be used. In the good case, the marking in column 25 is set to “1”, otherwise to “0”. Now a check is made, the calculation according to equation (10) shows that Zₖ and Zₗ are valid and accordingly the marking in column 26 is set. Furthermore, it is checked whether the regions are conclusive, then the marking is set in column 27. Then the signature Sₗ is verified with the corresponding public verification key available in the monitoring entity 2 and logged accordingly. If all checks have been successful and this has been recorded accordingly in the monitoring entity 2, the coin dataset is considered to have been switched. Thus, the coin dataset Cₖ is no longer valid and from now on the coin dataset Cₗ is valid. Double spending is no longer possible if a third terminal M3 inquires about the validity of the (double-spent) coin dataset at the monitoring entity 2. When checking the signature, it can be checked in pseudonymous mode whether the terminal M2 has exceeded a limit for monetary values. The check is carried out with regard to a time unit, for example a daily limit value could be monitored with it. If the limit value is exceeded, the monitoring entity 2 first refuses to switch the coin dataset Cₗ and requests the terminal M2 to de-anonymize. Depending on the system, de-anonymized switching may be permitted.

In optional step 109, a connecting of two coin datasets Cₖ and Cᵢ to a new coin dataset Cₘ is performed, invalidating the coin datasets Cₖ, Cᵢ and preventing double spending. To do this, the monetary value vₘ is formed from the two monetary values vₖ and vᵢ. For this purpose, the concealment value rₘ is formed from the two concealment values rₖ and rᵢ. In addition, the masked coin dataset Zₘ to be connected is obtained by equation (3) and this is sent (together with other information) to the monitoring entity 2 and the connecting is requested as processing. In addition, a signature Sₖ and a signature Sᵢ are generated and communicated to the monitoring entity 2.

In step 109′, the corresponding check is carried out in the monitoring entity 2. In the process, Zₘ is entered in column 23b according to the table in FIG. 2, which also corresponds to a transfer. A check is then made in monitoring entity 2 as to whether Zₖ and Zᵢ are (still) valid, i.e. whether the last processing of Zₖ or Zᵢ is entered in one of the columns 23a/b (as proof that Zₖ and Zᵢ have not been further split or deactivated or connected) and whether a check for the last processing has failed. In addition, the markings in columns 25, 26, 27 are initially set to “0”. Now a check is made whether Zₘ is valid, whereby the check according to equations (16) and (17) can be used. In the good case, the marking in column 25 is set to “I”, otherwise to “0”. Now a check is made, the calculation according to equation (10) shows that Zᵢ plus Zₖ equals Zₘ and accordingly the marking in column 26 is set. Furthermore, it is checked whether the ranges are conclusive, then the marking is set in column 27. When checking the signature, it can be checked whether the terminal M2 has exceeded a limit value for monetary values. The check is carried out with regard to a time unit, for example, a daily limit value could be monitored with it. If the limit value is exceeded, the monitoring entity 2 first refuses to connect the coin dataset Cₘ and requests the terminal M2 to de-anonymize. A de-anonymized connecting may then be permitted.

In optional step 110, an asymmetric splitting of a coin dataset Cᵢ into two coin datasets Cₖ and Cⱼ is performed, whereby the coin dataset Cᵢ is invalidated and the two asymmetrically split coin datasets Cₖ and Cⱼ are to be validated. In an asymmetric split, the monetary value vᵢ is split into monetary subvalues vₖ and vⱼ of different sizes. For this purpose, the concealment value rᵢ is divided into the two concealment values rₖ and rⱼ. In addition, by means of equation (3), the masked coin subdatasets Zₖ and Zⱼ are obtained and sent to the monitoring entity 2 with further information, for example the range checks (zero-knowledge-proofs), and the splitting is requested as processing. In addition, a signature Sᵢ is created and sent to the monitoring entity 2.

In step 110′, the corresponding check is carried out in monitoring entity 2, with Zⱼ and Zₖ being entered in columns 23a/b according to the table in FIG. 2. A check is then made in monitoring entity 2 as to whether Zᵢ is (still) valid, i.e. whether the last processing of Zᵢ is entered in one of the columns 23a/b (as proof that Zᵢ has not been further split or deactivated or connected) and whether a check for the last processing has failed. In addition, the markings in columns 25, 26, 27 are initially set to “0”. Now a check is made whether Zⱼ and Zₖ are valid, whereby the check according to equations (16) and (17) can be used. In the good case, the marking in column 25 is set to “1”. Now a check is made, the calculation according to equation (10) shows that Zᵢ is equal to Zₖ plus Zⱼ and accordingly the marking in column 26 is set. Furthermore, it is checked whether the ranges are conclusive, then the marking is set in column 27. When checking the signature, it can be checked whether the terminal M2 has exceeded a limit value for monetary values. The check is carried out with regard to a time unit, for example, a daily limit value could be monitored with it. If the limit is exceeded, the monitoring entity 2 first refuses to split the coin dataset Cᵢ and requests the terminal M2 to de-anonymize. A de-anonymized splitting may then be permitted.

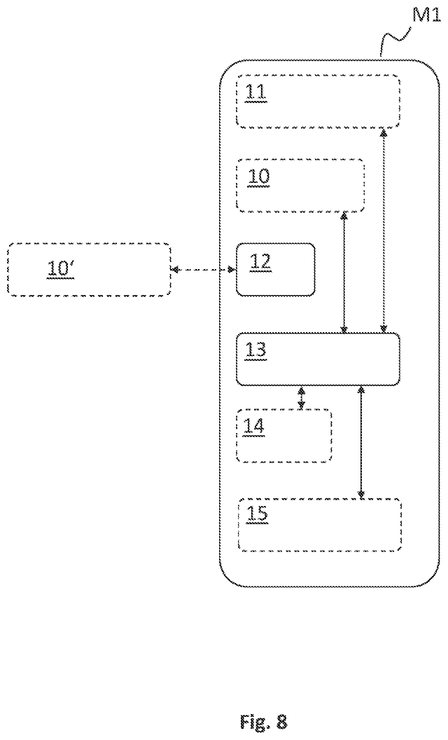

FIG. 8 shows an embodiment example of a device M1 according to the invention. The device M1 can store electronic coin datasets Cᵢ in a data memory 10, 10′. Thereby the electronic coin datasets Cᵢ are stored in the data memory 10 of the device M1 or are available in an external data memory 10′. When using an external data memory 10′, the electronic coin datasets Cᵢ could be stored in an online memory, for example a data memory 10′ of a digital wallet provider. Additionally, private data storage, for example a network attached storage, NAS, in a private network could also be used.

In one case, the electronic coin dataset Cᵢ is represented as a printout on paper. In this case, the electronic coin dataset may be represented by a QR code, an image of a QR code, or may be a file or a string (ASCII).

The device M1 has at least one interface 12 available as a communication channel for outputting the coin dataset Cᵢ. This interface 12 is for example an optical interface, for example for displaying the coin dataset Cᵢ on a display unit (display), or a printer for printing out the electronic coin dataset Cᵢ as a paper printout. This interface 12 can also be a digital communication interface, for example for near field communication, such as NFC, Bluetooth, or an internet-enabled interface, such as TCP, IP, UDP, HTTP or an access to a smart card as a security element. For example, this interface 12 is a data interface such that the coin dataset Cᵢ is transmitted between devices via an application, such as an instant messenger service, or as a file or string.

Furthermore, the interface 12 or a further interface (not shown) of the device M1 is configured to interact with the monitoring entity 2 according to the description in FIGS. 1 to 6. The device M1 is preferably online-capable for this purpose.

Furthermore, the device M1 may also have an interface for receiving electronic coin datasets. This interface is configured to receive visually presented coin datasets, for example by means of a capture module such as a camera or scanner, or digitally presented coin datasets, received via NFC, Bluetooth, TCP, IP, UDP, HTTP or coin datasets presented by means of an application.

The device M1 also comprises a computing unit 13 capable of performing the method described above for masking coin datasets and the processing on coin datasets.

The device M1 is online-capable and can preferably detect when it is connected to a WLAN by means of a location detection module 15. Optionally, a specific WLAN network can be marked as preferred (=location zone) so that the device M1 only performs special functions if it is logged into this WLAN network. Alternatively, the location detection module 15 detects when the device M1 is within predefined GPS coordinates including a defined radius and performs the special functions according to the location zone thus defined. This location zone can either be manually introduced into the unit M1 or via other units/modules into the unit M1. The special functions performed by the device M1 when the location zone is detected are in particular the transmitting of electronic coin datasets from/to the external data memory 10 from/to a vault module 14 and, if applicable, the transmitting of masked coin datasets Z to the monitoring entity 2, for example as part of the above-mentioned processing operations on a coin dataset.

In the simplest case, all coin datasets Cᵢ are automatically connected to a coin dataset in the terminal M1 after receipt (see connect-processing or connect-step). That is, as soon as a new electronic coin dataset is received, a connect or switch command is sent to the monitoring entity 2. The device M1 can also prepare electronic coin datasets in algorithmically defined denominations and hold them in the data memory 10, 10′ so that a payment method is possible even without a data connection to the monitoring entity 2.

FIG. 9 shows a flow chart of a method, with which, for example, compliance with a limit value for monetary values per time unit is made possible.

In the upper part of the figure, the payment system consisting of three terminals M1, M2, M3 is shown. In the lower part of the figure, two data structures 910, 920 of the monitoring entity 2 are shown. In the data structure 910, the valid masked coin datasets Zᵢ are stored. The data structure 920 comprises the association of pseudonymously sent masked coin datasets with the pseudonym and can be regarded as a register of pseudonymously sent coin datasets still to be checked. On the basis of the data in data structure 920, monitoring entity 2 can decide whether a range proof is requested for a pseudonym.

The following transactions were performed:
1. The first terminal M1 has split a coin 901. Thus, the monitoring entity 2 knows that the coin C1 is a result of this split and stores the masked coin dataset Z1 in the data structure 910. the first terminal M1 could send the split to the monitoring entity 2 anonymously or pseudonymously. In the illustration, it is assumed that the terminals M1 and M3 send their masked coin datasets anonymously to the monitoring entity 2.
2. The first terminal M1 sends the coin C1 directly to the second terminal M2 in a direct transmission step 902. The monitoring entity 2 does not receive any information about this.
3. The second terminal M2 converts (switches) the coin C1 to the coin C2 903. The new masked coin dataset Z2 is stored in the data structure 910 and the old masked coin dataset Z1 is deleted (or marked as invalid). The second terminal M2 sends its masked (or at least the represented) coin dataset pseudonymized to the monitoring entity 2. Thus, the monitoring entity 2 also receives the information that the second terminal M2 with the pseudonym P_{M2} has received the coin C1 (and now possesses coin C2) and stores accordingly in the data structure 920 Z2 (and/or Z1) for P_{M2}.
In addition, the monitoring entity 2 will skip at least one checking step, such as a range proof for the coin dataset Z2 or a sum range proof for the terminal M2.
4. The second terminal M2 sends the coin C2 to the third terminal M3 in a further direct transmission step 902. Monitoring entity 2 does not receive any information about this.
5. The third terminal M3 connects the received coin C2 to the connected coin C3 in step 904 and sends this information with anonymous masked coin datasets to the monitoring entity 2. The monitoring entity 2 therefore first performs all checking steps, thus in particular all range proofs for the masked coin datasets involved Z2 . . . and Z3 or also a sum range proof for the third terminal M3. The monitoring entity 2 only then deletes the masked coin dataset Z2 (as well as the other coin datasets of the operation) from the data structure 910 and stores the new masked coin dataset Z3 as a valid masked coin dataset.
6. In step 902, the third terminal M3 sends the coin C3 directly to the second terminal M2. Again, the monitoring entity 2 does not receive any information about this.
7. In a further step 903, the second terminal M2 converts (switches) the coin C3 into the coin C4 and sends a masked coin dataset Z4 together with its pseudonym to the monitoring entity 2. The monitoring entity 2 receives the information and carries out the necessary checks. Using the data structure 920, the monitoring entity 2 determines whether one or multiple checks should now be caught up for the pseudonym of the terminal M2. If the criterion for a catch-up, such as time lapse or number of transactions for a pseudonym, is not yet fulfilled, only the further masked coin dataset Z4 for the pseudonym is noted in the data structure 920. The monitoring entity 2 stores the masked coin dataset Z4 in the data structure 910 and deletes the masked coin dataset Z3 there. If, on the other hand, a criterion for a checking step which can be caught up is fulfilled, it first performs the checking step which can be caught up (or its equivalent).

In the particular example, monitoring entity 2 has the information that the second terminal M2 had coin C2 (see step 3). Since the sum of the monetary values of coin C2 and coin C4 could exceed a coin threshold value, monitoring entity 2 requests a sum range proof (or sum range confirmation) from the second terminal M2. The sum range proof shows that the sum of the monetary values of the coins C2 and C4 does not yet exceed the—for example daily—limit of transactions for the second terminal M2. The monitoring entity 2 can also monitor a limit for a time-independent number of transactions (range proof after 3/5/10/ . . . transactions). Alternatively or in addition to a sum check of multiple coin datasets, the monitoring entity 2 can catch up a range check for the individual coin datasets linked to the pseudonym P_{M2} in the data structure 920 (Is the monetary value of each coin dataset Z2 and Z4 smaller than X?). If checks have been successfully caught up, the corresponding datasets in the data structure 920 can also be deleted.

FIG. 10 shows a further embodiment example of an operation in a payment system with masked coin datasets. A first terminal M1 sends anonymous masked coin datasets to the monitoring entity 2 in steps 151, whereas a second terminal M2 sends pseudonymized masked coin datasets to the monitoring entity 2 in steps 161.

The monitoring entity 2 responds to each of the anonymous sending steps 151 of the first terminal M1 (in its anonymous mode) with a check (which can be caught up) for the masked coin dataset or the first terminal M1. The additional necessary checks, if any, are not shown in FIG. 10. In step 152, for each masked coin dataset, the monitoring entity 2 requests a range proof that the monetary value of the masked coin dataset from step 151 is below a maximum value (or a corresponding range confirmation).

Alternatively or additionally, at step 152, the monitoring entity requests a sum range proof (or confirmation) from the first terminal M1. The requested proof (or proofs) shall be created by the first terminal M1 in step 153 and sent in step 154 in order for the (at least one) masked coin dataset of step 151 to be treated as valid in the monitoring entity 2.

The monitoring entity 2 responds to the first sending step 161 of the second terminal M2 (in its pseudonymous mode) by skipping a check (which can be caught up) for the masked coin dataset or the second terminal M2. The pseudonymously sent masked coin dataset is registered as valid. For example, necessary checks not shown here are performed but do not require further communication with the second terminal M2. As previously described in other examples, the monitoring entity 2 stores an association between the pseudonym and the pseudonymously sent masked coin dataset(s). In the example shown, the monitoring entity 2 also responds analogously to a second (or further) sending step 161 of the second terminal M2. In each case, it checks for the pseudonym whether a catch-up criterion is fulfilled.

Only in the third step 161 shown does the monitoring entity 2 determine that a check is to be caught up for the pseudonym. It sends a request 162 to the second terminal M2 to create, for example, range proofs for multiple coin datasets or a sum range proof. In step 163, the second terminal M2 creates multiple range proofs, a sum range proof, or a sum range confirmation and sends them to the monitoring entity 2 in step 164. In step 163, for example, a plurality of coin datasets of the second terminal M2 are selected and a sum is formed over their monetary values. These coin datasets concern either only pseudonymized coin datasets or anonymous and pseudonymized coin datasets (in this case, the masked coin datasets that have already been sent are used and the sum is formed from the monetary values of the corresponding unmasked coin datasets). The selecting can be done on the basis of criteria that are either known by the system or transmitted by the monitoring entity 2 in step 162. The criteria are, for example, a time period, in particular a predefined time period in which a sum of all monetary values should/must not exceed a certain range, for example a monetary value x euros per time unit y. The criterion can alternatively or additionally be a list in the first terminal M1 or the monitoring entity 2. This makes a certain randomization of the range possible with which the system is further secured. The formed sum is then matched with the range (and, if applicable, applying the criterion). In step 164, the requested sum range confirmation (or sum range proof) is transmitted from the second terminal M2 to the monitoring entity 2.

Since a payment transaction (transmitting coin datasets) of a large monetary value can also be split into multiple payment transactions of smaller monetary values, each of which could be below a range, the method defines the range (=limit value) on a terminal-specific and time period-dependent basis, if applicable. The range generally relates to a sum of all transactions within a certain time unit that are received and/or sent by a terminal. Therefore, a mechanism is provided to determine what the sum of all monetary values sent or received by a terminal is within a specific time unit.

Within the scope of the invention, all elements described and/or drawn and/or claimed may be combined with each other in any desired manner.

### LIST OF REFERENCE SIGNS

1 issuer entity or bank
2 monitoring entity
21 command entry
22a, b entry of a processed electronic coin dataset (predecessor)
23a, b entry of a processed electronic coin dataset (successor)
24 signature entry
25 marking of the validity check
26 marking of the calculation check
27a, 27b, 27c marking of the range proof check
28 marking of the signature check
29 completion marking
3 direct transaction layer
4 monitoring layer
5 application common wallet
10, 10′ data memory
11 display
12 interface
13 computing unit
14 vault module
15 location detection module
M1 first terminal
M2 second terminal
M3 third terminal
Cᵢ electronic coin dataset
Cⱼ, Cₖ split electronic coin dataset
Cₗ electronic coin dataset to be connected
Cₘ electronic coin dataset to be connected
Zᵢ masked electronic coin dataset
Zⱼ, Zₖ masked split electronic coin dataset
Zₗ masked split coin electronic dataset
Zₘ masked coin electronic dataset to be connected
S signed masked electronic coin dataset
vᵢ monetary value
vⱼ, vₖ divided monetary value
vₗ monetary value of an electronic coin dataset to be switched
vₘ monetary value of an electronic coin dataset to be connected
rᵢ concealment value, random number
rⱼ, rⱼ concealment value of a split electronic coin dataset
rₘ concealment value of a linked electronic coin dataset to be linked
Cᵢ* transmitted electronic coin dataset
Cⱼ*, Cₖ* transmitted split electronic coin dataset
Zᵢ* masked transmitted electronic coin dataset
Zⱼ*, Zₖ* masked transmitted split electronic coin dataset
f(C) (homomorphous) one-way function
[Zᵢ]Sig(SK₁) signature of the issuer entity
[Zᵢ]Sig(SK_{Mx}) signature of the terminal
151-154, 161-164 method steps according to an embodiment example
901-904 method steps according to an embodiment example
210, 910 register of the monitoring entity
220, 920 additional data structure of the monitoring entity

1.-14. (canceled)

15. A method for directly transmitting electronic coin datasets between terminals,
wherein a monitoring entity registers anonymous masked electronic coin datasets, comprising the following steps in a first terminal;
receiving an electronic coin dataset, the at least one electronic coin dataset having a monetary value and a concealment value;
masking a modified electronic coin dataset or the received electronic coin dataset by applying a one-way function to the electronic coin dataset, to its concealment value in order to obtain a masked electronic coin dataset;
linking the masked electronic coin dataset to a pseudonym in order to obtain a pseudonymized masked electronic coin dataset; and
sending the pseudonymized masked electronic coin dataset to the monitoring entity.

16. The method according to claim 15, wherein the number of range confirmations or range proofs that the monitoring entity requests from the first terminal is reduced by the sending of the pseudonymized masked electronic coin dataset instead of an anonymous masked electronic coin dataset.

17. The method according to claim 15, comprising the further steps in the first terminal:
receiving a request for a sum range confirmation or a sum range proof from the monitoring entity; and
sending the requested sum range confirmation or the requested sum range proof to the monitoring entity.

18. The method according to claim 15, comprising the further steps in the first terminal:
creating an unsolicited sum range confirmation or an unsolicited sum range proof, and
sending the unsolicited sum range confirmation or the requested sum range proof to the monitoring entity.

19. The method according to claim 15, wherein the first terminal forms a sum of monetary values of multiple electronic coin datasets, and
wherein the first terminal confirms with the sum range confirmation that the formed sum is in a range.

20. The method according to claim 15, wherein the first terminal creates a sum range proof for multiple electronic coin datasets which can be checked by the monitoring entity.

21. The method according to claim 19, wherein the multiple electronic coin datasets comprise only selected electronic coin datasets, including
only electronic coin datasets of sent pseudonymized masked electronic coin datasets, or
only electronic coin datasets of sent anonymous masked electronic coin datasets or sent pseudonymized masked electronic coin datasets, or
only electronic coin datasets of sent anonymous masked electronic coin datasets, sent pseudonymized masked electronic coin datasets and/or masked electronic coin datasets not sent to the monitoring entity.

22. The method according to claim 19, wherein the multiple electronic coin datasets are selected according to at least one of the following criteria:
a preselected time period, and/or
a list in the first terminal or in the monitoring entity.

23. The method according to claim 15, wherein the monitoring entity requests range confirmations or range proofs from terminals in the context of a sum check, and:
applies a first sum check mode for anonymous masked electronic coin datasets,
applies a second sum check mode for pseudonymous masked electronic coin datasets.

24. The method according to claim 15, wherein the monitoring entity checks a range proof for the value for each received modified coin dataset.

25. The method according to claim 15, wherein the monitoring entity
regularly or quasi-randomly requests range confirmations or range proofs from terminals, and/or
only after a number of coin data datasets received for a pseudonym requests a range confirmation or a range verification from the terminal device,
wherein the number is dependent on the terminal type and/or the coin value range.

26. A terminal configured for directly transmitting electronic coin datasets between terminals having a computing unit configured for carrying out the terminal steps of the method according to claim 15.

27. A monitoring entity configured for directly transmitting electronic coin datasets between terminals having a computing unit configured for carrying out the method according to claim 15, which in particular registers anonymous masked electronic coin datasets and registers pseudonymously sent masked electronic coin datasets.

28. A payment system for exchanging monetary values, the payment system comprising:
a monitoring layer with a database in which anonymous masked electronic coin datasets are stored; and
a direct transaction layer, with at least two terminals, in which the method according to claim 15 may be performed.
